(19) United States
(12) Patent Application Publication
(10) Pub. No.: US 2025/0330301 A1
(43) Pub. Date: Oct. 23, 2025

(54) Devices, Systems, Software, and Methods for Efficient Data Processing for Fully Homomorphic Encryption, Post-Quantum Cryptography, Artificial Intelligence, and other Applications

(71) Applicant: Astrapi Corporation, Dallas, TX (US)

(72) Inventor: Jerrold PROTHERO, Delray Beach, FL (US)

(73) Assignee: Astrapi Corporation, Dallas, TX (US)

(21) Appl. No.: 19/171,173

(22) Filed: Apr. 4, 2025

Related U.S. Application Data
(63) Continuation of application No. 17/851,408, filed on Jun. 28, 2022.
(60) Provisional application No. 63/215,800, filed on Jun. 28, 2021.

(51) Int. Cl. H04L 9/00; H04L 9/08; H04L 9/30

(52) U.S. Cl. CPC H04L 9/008; H04L 9/0852; H04L 9/3093

(57) ABSTRACT

Systems, devices, software, and methods of the present invention provide for homomorphically encrypted (HE) and other data represented as polynomials of degree K-1 to be transformed in 0(K*log (K)) time into ‘unique-spiral’ representations in which both linear-time (0(K)) addition and linear-time multiplication are supported without requiring an intervening transformation. This capability has never previously been available and enables very significant efficiency improvements, i.e., reduced runtimes, for applications such as Fully Homomorphic Encryption (FHE), Post-Quantum Cryptography (PQC) and Artificial Intelligence (AI). Other efficient operations, such as polynomial division, raising to a power, integration, differentiation and parameter-shifting are also possible using the unique-spiral representations. New methods are introduced based on the unique-spiral representation that have applications to efficient polynomial composition, inversion, and other important topics.

### CROSS-REFERENCE TO RELATED APPLICATIONS

This application is a continuation of U.S. patent application Ser. No. 17/851,408, filed on Jun. 28, 2022, which claims the benefit of and priority from U.S. Provisional Patent Application No. 63/215,800, filed on Jun. 28, 2021, entitled “Devices, Systems, Software, and Methods for Efficient Data Processing for Homomorphic Encryption, Artificial Intelligence, and other Applications”, the entire disclosure of each is hereby incorporated by reference.

### BACKGROUND OF THE INVENTION

### Field of the Invention

The present invention relates in general to processing data, and more specifically to providing higher performance polynomial-based mathematical operations for applications that may employ Fully Homomorphic Encryption (FHE), Post-Quantum Cryptography (PQC), Artificial Intelligence (AI), and other data processing techniques, such as surveillance signal analysis and identification, autonomous vehicle and other machine operation, data communications, networking and control, etc.

### Background Art

FHE is a rapidly-emerging field in cryptography. FHE attempts to address the problem of how to protect (keep secret) data not only when at rest or in transit, but also while the data are being operated on, i.e., processed, such as being used in a computation or otherwise. FHE, as addressed here, support general arithmetic operations and in particular both addition and multiplication. There are also more limited versions of homomorphic encryption. See en.wikipedia.org/wiki/Homomorphic_encryption for additional background.

In traditional (non-FHE) encryption, the encryption algorithm effectively randomizes the encrypted data, destroying any structure the data might have had until it is decrypted. As such, the data must be unencrypted/decrypted before the data may be operated upon, leaving the data unsecure during that time.

The power of FHE is that the data is encrypted without destroying its structure, allowing mathematical operations to be performed on the encrypted data as if it were unencrypted. FIG. 1, which is reproduced from DARPA Broad Agency Announcement (BAA), Data Protection in Virtual Environments (DPRIVE), Microsystems Technology Office, HR001120S0032, Feb. 27, 2020, Amendment 1 as amended Mar. 19, 2020, sam.gov/opp/16c71dadbe814127b475ce309929374b/view (herein “DPRIVE”) FIG. 1, depicts exemplary data states for systems employing non-HE and HE encryption and performing operations on data.

The DPRIVE BAA identifies one of and perhaps the most significant problem with known FHE techniques, which is computational inefficiency. While FHE techniques were developed to enable operations to be performed on encrypted data, existing hardware and techniques do not do it well or well enough for FHE to be useful for real world application.

For example, as shown in FIG. 3 of the DPRIVE BAA, a calculation that takes less than an hour unencrypted would currently take more than a year with FHE. As such, current computer architectures, hardware, and processing techniques are not capable of performing the tasks required for most applications in which FHE or PQC. The problem is so significant that the goal of DARPA's DPRIVE initiative is not to solve the problem, but to reduce this disparity to a factor of ten, so that a FHE calculation would take only ten times longer than an equivalent unencrypted calculation.

PQC and AI are other technology areas that are computationally intensive. PQC and AI technology have great potential for many applications. However, many PQC and AI technologies and implementations suffer the same computational challenges as FHE implementations. As such, the implementation of PQC and AI techniques is limited for many applications, due to the inability of computer technologies to process data in a timely manner.

A source of computational inefficiency results from the inability of present technologies to perform mathematical operations on polynomials efficiently. Particularly important, because of its very frequent use, is multiplication, which in the simplest implementation is 0(K²), where K is the number of polynomial coefficients. A solution known to the art for efficient polynomial multiplication is to use a Number-Theoretic Transform (NTT), which is a generalization of the classic Discrete Fourier Transform (DFT) to finite fields. Using the NTT, in 0(K*log (K)) time polynomials may be transformed into “NTT-space”, in which polynomials may be multiplied in linear time (equivalently, 0(K)).

However, in the NTT-space representation polynomial addition is impossible. Since FHE must support both addition and multiplication to support any possible calculation, FHE requires continually using both the NTT transform, to support efficient polynomial multiplication, and an inverse NTT transform (INTT) to a representation to support polynomial addition. For example, to perform an efficient multiplication operation and then an addition operation one has to use the NTT transform, perform the multiplication, then use the INTT operation to perform the addition operation, all of which takes time and thereby slows down the overall speed of performance. The inefficiencies of the mathematical computations and transformations in combination with the FHE-encryption processes contributes significantly to the dramatically longer runtimes for FHE calculations compared to unencrypted calculations. Additionally, the necessity for the NTT and INTT prevents composing functions and streamlining data management, imposing further very significant impediments to computational efficiency.

As such, there is a continuing need for systems, devices, software, and methods for FHE, AI, and other data processing with higher computational performance to enable a wide range of applications, particularly in the fields of requiring data privacy and/or real time applications, such as financial transactions, autonomous vehicle and other machine operation, data communications, networking and control, privacy & security, etc.

### BRIEF SUMMARY OF THE INVENTION

Systems, devices, software, and methods of the present invention provide for improved methods of processing encrypted data that enable a wide range of transactions and analyses to be performed in a useful time frame using FHE. In the present invention, data to be processed may be homomorphically encrypted (HE) to represent the data as a polynomial with K coefficients (i.e., of degree K-1) and having polynomial coefficients cₖ. The polynomial coefficients cₖ representing the HE data are then transformed into an equivalent multi-spiral representation in terms of coefficients of sums of complex spirals, cₘₙ. The multi-spiral coefficients cₘₙ are then transformed to the equivalent cₘₚ “unique-spiral” coefficients, in which each cₘₚ coefficient is a weight to a single complex spiral, specified by its indices m and p.

Operations, such as addition and multiplication, may be performed in linear runtime, 0(K), on the data in unique-spiral coefficient form. Other efficient (0(K)) operations may also be performed in unique-spiral coefficient form, including polynomial division, raising a polynomial to a power, integration, differentiation, and parameter-shifting.

Upon completion of one or more operations, the output of the operations may be converted, or transformed, back from unique-spiral coefficients cₘₚ form to multi-spiral coefficients cₘₙ, then to standard polynomial coefficients cₖ and decrypted and/or further processed. In various embodiments, the transformations, which only have to be performed before and after the operations on the data, may be performed as 0−(K²) runtime matrix multiplications (suitable for understanding the processes) or as 0(K*log (K)) (for efficiency) runtime operations.

The conversion of multi-spiral representations into unique-spiral representations may be performed using a transformation matrix, such as

$$A ( n , p ) = {i}^{- n ( 2 p + 1 ) {2}^{2 - m}} ,$$

where m represents a set (“level”) of Cairns functions, n represents a particular function within an m-level, and p specifies a particular spiral associated with m and n. An inverse of the transformation matrix may be used to convert from unique-spiral representations to multi-spiral representations.

The capability to perform various operations on the unique-spiral coefficient form of the encrypted data without intervening NTT, NTTI or other transformations eliminates the need for the continual and computationally and time-expensive transformations in current FHE or other implementations, which dramatically reduces the runtime for any process using the present invention and enables entire classes of applications to be performed securely that were not possible with the prior art due to the extremely long processing time for other FHE operational methodologies.

The above techniques may be employed within any application, including FHE, PQC, or AI applications, that may benefit from employing polynomial representations of data and performing operations on those representations, particularly, but not exclusively, the operations of addition and multiplication.

It is estimated that for a full-scale FHE system, the present invention may provide an improvement of 100× in runtime. With computational acceleration of 2*log (n)*(multiplicative depth of circuit), where n is often 1000-10000, the acceleration equates to speedups of 300×for a depth 15 circuit. The multiplicative depth of PQC systems is usually 3 with n of 100-1000 yielding a speedup of 50×. In the present invention, polynomial operations are composable and may be fused to increase locality and reduce memory bandwidth requirements. The speedup provided by the present invention may be used to enable post-quantum block chains and perfect forward secrecy communications and FHE across small federated neural networks trained on encrypted inputs, voting systems, small-scale Private Information Retrieval (end-to-end encrypted databases). The present invention may be enabled in ASICs to provide additional acceleration that may enable FHE to become feasible for many real-world end-to-end encrypted applications (data-at-rest, data-in-use, data-in-motion), such as Private Information Retrieval, Privacy protected data analytics and machine learning, and Privacy-preserving outsourced storage and computation. A 50× reduction in computational time means that computations that used to take a year, now take a week, and transactions normally requiring a minute may be completed in seconds. The preceding examples should be taken as exemplary and not in any way limiting.

In practice, input data may be provided to the various processors, systems, devices, software, etc. by one or more of user input, extraction from data in a memory or other storage, wired communication, wireless communication, software, and hardware that may be located at one or more local and/or remote locations. The input data and transactions performed may involve financial, healthcare, security, privacy, and technology data or just general data processing and involve recording transactions, database searches, etc. For example, consider financial transactions in which a seller's account may be receiving a payment from a buyer account in a payment amount. The amounts in the seller's and buyer's accounts and the payment amount may all be encrypted. Using the above procedure, unique-spiral representations of the various amounts would be generated and the addition and subtraction of the payment amount from the amounts in the seller's and buyer's account would be performed using the unique-spiral representations without decrypting the amounts with the output being the new account balances resulting from the payment. An interest rate or fee could be applied using multiplication within the same methodology. Similarly, input data may be compared to database values, possibly to calculations performed on database values, to identify various relationships between the input data and the database values, such as confirming identity and other privacy and security applications.

Multiple parties may be involved in various transactions involving encrypted or unencrypted data. The data owner may generate polynomial representations of input data, which may or may not be encrypted, then transform the polynomial representation of the data first into a multi-spiral representation and then into the corresponding unique-spiral representation. The owner may then transmit the unique-spiral representation to one or more third parties as input unique-spiral representations. The third parties may receive input unique-spiral representation and perform one or more mathematical operations to generate output unique-spiral representations, which are transmitted back to the owner of the data. The data owner may then transform the output unique-spiral representation into output multi-spiral representations and then into output data polynomial representations, which may be further transformed to output data.

As may be disclosed, taught, and/or suggested herein to the skilled artisan, the present invention provides a unique solution to the problem of computational inefficiencies that have limited FHE, PQC, AI, and other data processing applications, thereby addressing a long felt need across industries that has never been met for implementations that may be employed in real-life and real-time. In this manner, the present invention enables entirely new systems, devices, and methods for processing data and particularly encrypted data applications that employ polynomials to represent the data. The advancement represented by the present invention is unique in that it is not merely an automation of a known process, but an entirely new technique that provides a solution that is demonstrably better than any solution proposed to date.

### BRIEF DESCRIPTION OF THE DRAWINGS

Advantages of embodiments of the present invention will be apparent from the following detailed description of the exemplary embodiments thereof, which description should be considered in conjunction with the accompanying drawings, which are included for the purpose of exemplary illustration of various aspects of the present invention to aid in description, and not for purposes of limiting the invention.

FIG. 1 illustrates data states in exemplary non-FHE and FHE systems.

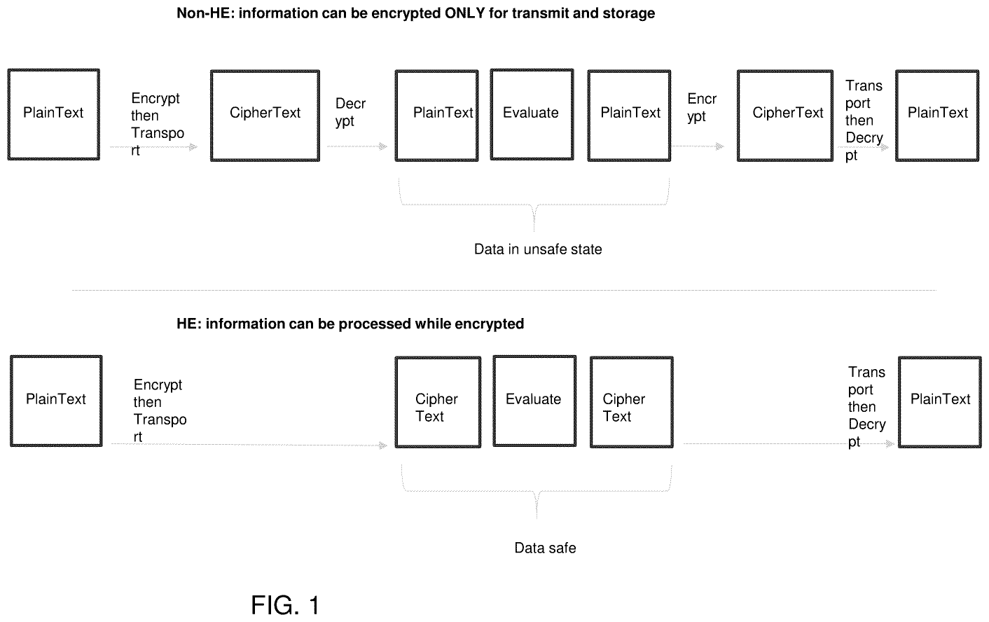

FIG. 2 shows the (unnormalized) Cairns series coefficients, which define the Cairns projection matrix.

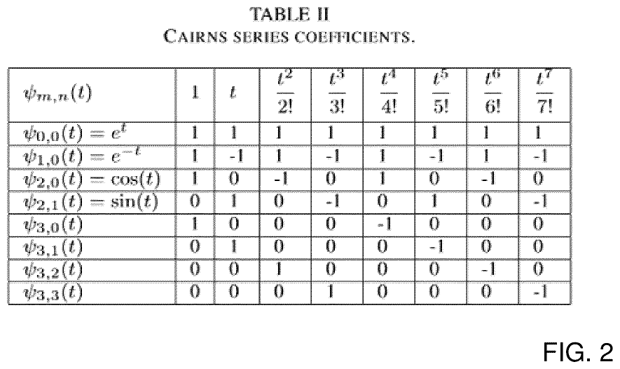

FIG. 3 depicts systems and/or devices embodying the present invention in a network.

FIG. 4 depicts computing resources that may be used to implement the present invention.

In the drawings and detailed description, the same or similar reference numbers may identify the same or similar elements. It will be appreciated that the implementations, features, etc., described with respect to embodiments in specific figures may be implemented with respect to other embodiments in other figures, unless expressly stated, or otherwise not possible.

### DETAILED DESCRIPTION OF THE INVENTION

Systems, devices, software, and methods of the present invention provide for improved methods of processing data that may be expressed as polynomials, and particularly encrypted data that enable a wide range of transactions and analyses to be performed in a useful time frame using fully homomorphic encryption, as well as with other systems and devices that require efficient polynomial operations, for instance PQC and AI. In the present invention, data to be processed may be homomorphically encrypted (HE) to represent the data as a polynomial of degree K-1 and having polynomial coefficients cₖ. In some cases, Taylor polynomials may be used in which coefficients are scaled by 1/k! as known to those skilled in the art.

The polynomial coefficients cₖ representing the HE or other data are then transformed into an equivalent multi-spiral representation in terms of coefficients of sums of complex spirals, cₘₙ. The multi-spiral coefficients cₘₙ are then transformed to the equivalent cₘₚ “unique-spiral” coefficients, in which each cₘₚ coefficient is a weight to a single complex spiral specified by its indices m and p.

The operational interpretations of m, n, and p follow directly from the definitions of Eₘₙ(t) and Eₘₚ(t) as given below.

The value of m defines a fractional power of the imaginary constant i, which has the effect of defining the geometry of a spiral in terms of a trade-off between the rate of rotational and the rate of amplitude variation. For instance, m=0 and m=1 corresponds to the familiar rising and decaying exponentials, respectively. These can be thought of as the limiting case of spirals that have amplitude variation but no rotation. m=2 corresponds to the well-known complex circles from which the cosine and sine functions are derived. A circle is the limiting case of spirals that rotate but have no amplitude variation. For increasing values of m>2 the rate of amplitude variation increases, and the rate of rotation decreases. The term “m-level” is used to refer collectively to all functions which have the same m-value.

The values of p enumerate incremental variations of the spiral geometry implied by m. It affects both rate amplitude variation and rate of rotation, including whether the amplitude grows or shrinks with time, and whether the rotational direction is positive or negative. The number of variations increases with larger m. Every spiral used in the present invention is uniquely defined by the combined values of m and p, hence the term “unique spiral” for the cₘₚ coefficients. For instance, in the well-known case of cos (t)=(e^{it}+e^{-it})/2, it can be seen from the definition of Eₘₚ(t) given below that e^{it} corresponds to m=2, p=0 and e^{-it} corresponds to m=2, p=1. p may be called the unique spiral specification value, although this is only true if the m-level is also known.

The value of n specifies the number of times that the unique spirals have been integrated. n=0 implies no integration, successive (positive) values of n correspond to successive integrations. n may therefore be called the “integration number”.

The coefficients cₘₙ are applied to the sum of all unique spirals at the same m-level that have the same integration number n.

The transition from cₘₙ multi-spiral coefficients to cₘₚ unique-spiral coefficients essentially corresponds to summing across integration numbers to isolate the coefficients that apply to each unique spiral.

Operations, such as addition and multiplication, may be performed in linear runtime 0(K), on the data in unique-spiral coefficient form. Other efficient (0(K)) operations may also be performed in unique-spiral coefficient form, including polynomial division, raising a polynomial to a power, integration, differentiation, and parameter-shifting.

Upon completion of one or more operations, the output of the operations may be transformed, or converted, back from unique-spiral coefficients cₘₚ form to multi-spiral coefficients cₘₙ, then to standard polynomial coefficients cₖ and decrypted and/or further processed. In various embodiments, the transformations, which only have to be performed before and after the operations on the data, may be performed as 0(K²) (for clarity) or more efficiently as 0(K*log (K)) runtime operations.

The symbols cₖ, cₘₙ, and cₘₚ here notate respectively the standard polynomial coefficients, the coefficients for the ‘Cairns’ or ‘multi-spiral’ functions Eₘₙ(t) (defined below), and the coefficients for the ‘unique-spiral’ functions Eₘₚ(t) (defined below). The present invention makes use of and extends the inventor's previous inventions described as Instantaneous Spectral Analysis (ISA), which are described in the U.S. Pat. No. 10,069,664 entitled “Spiral Polynomial Division Multiplexing” (US664), and Prothero, J., Islam, K. Z., Rodrigues, H., Mendes, L., Gutiérrez, J., & Montalban, J. (2019), Instantaneous Spectral Analysis. Journal of Communication and Information Systems, v34, n1, pp. 12-26, doi.org/10.14209/jcis.2019.2 (referred to herein as “ISA-2019”), the disclosures of which are herein incorporated by reference in their entirety.

The capital letters K, M, N, and P represent limiting values for the corresponding lower-case variables in a particular configuration. Specifically, K is the number of polynomial coefficients (so that c_{K-1} is the coefficient of the highest-power non-zero term); M=log₂ (K) is the range of possible m-values such that 0≤m≤2^{M}; and N=P= [2^{m-1}] with 0≤n<N−1 and 0≤p<P−1. K must be a positive integer power of two.

Algorithmic runtime is expressed with respect to the number of polynomial coefficients K (e.g., 0(K) for linear runtime), rather than the usual n or N notation, because n and N are not used here in a way that reflects the total problem size.

Where multiple polynomials are under consideration, c may be changed to another letter to distinguish between the polynomials without requiring an additional subscript or superscript. For instance, polynomials A, B and C, written P_{A}(t), P_{B}(t), P_{c}(t), may respectively be described by coefficients aₖ, aₘₙ, aₘₚ; bₖ, bₘₙ, bₘₚ; and cₖ, Eₘₙ, cₘₚ.

A possible confusion with numeric subscripts is that it may not be immediately clear that two subscripts are specified unless a comma is inserted between them. Thus, we write cₘₙ without a comma, but c_{2,1} with a comma separating the numeric m and n values (not c₂₁).

Another possible confusion with numeric values arises from the distinction between n and p for cₘₙ and cₘₚ. Where necessary to avoid ambiguity, this is addressed by providing the subscript explicitly: e.g., c_{4,n=3} or c_{4,p=3}, where the m value of 4 is unambiguous, but whether the second subscript refers to n or to p could be ambiguous.

All of the coefficients viewed collectively as a vector, generally for matrix multiplication purposes, are denoted with the standard arrow notation: i.e., [symbol] ₖ, [symbol] ₘₙ and [symbol] ₘₚ. Coefficients are entered into these vectors in order of increasing k for cₖ, and of increasing m with increasing n or p for each value of m in the case of [symbol] ₘₙ and [symbol] ₘₚ.

The standard ‘dot’ or ‘inner’ product of two vectors is indicated by the usual ° symbol: for instance, [symbol] ₀° [symbol] ₁.

As is known to the art, an invertible linear transform from one coefficient space to another may be performed by multiplying a vector of coefficients by an ‘orthonormal’ matrix: that is, a matrix in which all the rows and columns are orthogonal (i.e., dot product of zero between all distinct rows and between all distinct columns) and normalized (the length of each row or column, measured as the square root of the sum of the squared coefficients, is equal to one).

The terms ‘transformation’, ‘projection’ and ‘map’ are used interchangeably herein. The terms ‘representation’ and ‘space’ are also used interchangeably, as for example “cₘₚ unique-spiral representation” or “cₘₚ unique-spiral space”

An orthogonal (but not necessarily normalized) transform is notated as Q, and the corresponding normalized transform is notated \hat{Q}. The relevance of unnormalized transforms, rather than the usual normalized transforms, will be discussed below in the context of “delayed normalization”. The unnormalized transform from cₖ to cₘₙ coefficients is denoted Q_{k→mn}, and similarly Q_{mn→mp} for the transformation from cₘₙ to cₘₚ coefficients.

When these transforms are implemented as matrices it is known to the art that the transform may be composed by standard matrix multiplication to produce the composite transformation Q_{k→mp}. The corresponding inverse transformations may be notated respectively as Q_{mn→k}, Q_{mp→mn}, and Q_{mp→k}, or equivalently as

$${Q}_{k \to mn}^{- 1} , {Q}_{mn \to mp}^{- 1} and {Q}_{k \to mp}^{- 1} .$$

Unoptimized matrix multiplication is known to run in 0(K²) time, since the number of entries in the matrix, and therefore the number of multiplications performed, is the square of the number of vector coefficients. The unoptimized matrix multiplication versions may be called the “slow” versions of the above transforms.

Techniques have been developed and are disclosed herein to enable an equivalent and much more efficient 0(K*log (K)) implementation of the transforms, which are referred to herein as the “fast” versions of the transforms. One of skill in the art will appreciate that the fast transforms are more desirable for a production implementation, because of the dramatically shortened runtime relative to the slow transforms. The slow versions may be useful for clarifying the underlying operations and relationships, facilitating proofs, etc.

The techniques used here employ terms with fractional powers of i in the exponent, such as

$${e}^{{ti}^{1 / 2}} ,$$

and more generally

$${e}^{{ti}^{( 2 p + 1 ) {2}^{2 - m}}} ,$$

for integer m, p≥0. The application of the important operation of conjugation to fractional powers of i is not generally familiar to the art. The point of conjugation is that multiplication of a complex term by its conjugate should return the square of the amplitude of the term while removing (making equal to zero) its angle in the complex plane. For instance, in practice known to the art, the term ae^{it} has conjugate ae^{-it}, so that ae^{it} ae^{-it}=a² e^{it-it}=a² e⁰=a².

The practice of forming the conjugate by taking the negative of the imaginary exponent does not generalize to exponentials with fractional powers of i. For instance, exploiting the Euler equation identity i=e^{iπ/2}, i^{1/2} may be written as:

$${i}^{1 / 2} = {( {e}^{\frac{i π}{2}} )}^{1 / 2} = {e}^{i π / 4} = cos ( \frac{π}{4} ) + i * sin ( \frac{π}{4} ) \qquad ( 1 )$$

and therefore

$${ae}^{{ti}^{1 / 2}} = {ae}^{cos ( \frac{π}{4} ) t} {e}^{i * sin ( \frac{π}{4} ) t} \qquad ( 2 )$$

Forming the conjugate in the traditional way by putting a negation in front of i results in

$${ae}^{- {ti}^{1 / 2}} = {ae}^{- cos ( \frac{π}{4} ) t} {e}^{- i * sin ( \frac{π}{4} ) t} \qquad ( 3 )$$

which when multiplied this the original term

$${ae}^{{ti}^{1 / 2}} {ae}^{- {ti}^{1 / 2}} = {ae}^{cos ( \frac{π}{4} ) t} {e}^{i * sin ( \frac{π}{4} ) t} {ae}^{- cos ( \frac{π}{4} ) t} {e}^{- i * sin ( \frac{π}{4} ) t} = {a}^{2} \qquad ( 4 )$$

results in

$${ae}^{{ti}^{1 / 2}} ,$$

The above correctly removes the angular factor

$${e}^{i * sin ( \frac{π}{4} ) t} ,$$

which we want multiplication by the conjugate to do. However, it also incorrectly removes the amplitude factor

$${e}^{cos ( \frac{π}{4} ) t} .$$

This factor is what distinguishes a complex spiral from a complex circle: the amplitude varies with time.

Multiplication by the complex conjugate should return the result

$${a}^{2} {e}^{2 * cos ( \frac{π}{4} ) t} ,$$

which may be achieved by putting the negation not in front of the factor of i, but rather in its exponent. Thus

$${e}^{{ti}^{- 1 / 2}} = {e}^{cos ( - \frac{π}{4} ) t} {e}^{i * sin ( - \frac{π}{4} ) t} = {e}^{cos ( \frac{π}{4} ) t} {e}^{- i * sin ( \frac{π}{4} ) t} \qquad ( 5 )$$

The above exploits the fact that the cosine function is symmetric, cos (−x)=cos (x), and the sine function is anti-symmetric, sin (−x)=−sin (x).

Using the above results in:

$${ae}^{{ti}^{1 / 2}} {ae}^{{ti}^{- 1 / 2}} = {ae}^{cos ( \frac{π}{4} ) t} {e}^{i * sin ( \frac{π}{4} ) t} {ae}^{cos ( \frac{π}{4} ) t} {e}^{- i * sin ( \frac{π}{4} ) t} = {a}^{2} {e}^{2 * cos ( \frac{π}{4} ) t} \qquad ( 6 )$$

As such

$${e}^{{ti}^{- 1 / 2}}$$

has the necessary properties to be the conjugate of

$${e}^{{ti}^{1 / 2}} .$$

The general case, following directly from the above i^{1/2} example, is that for any q the conjugate of ae^{ti}^{^{q}} is ae^{ti}^{^{−q}}. In the special case q=1, the identity

$${i}^{- 1} = \frac{1}{i} = \frac{i}{ii} = \frac{i}{- 1} = - i$$

may be used to show that the conjugate ae^{ti}^{^{−1}} is equal to the familiar ae^{-it}. However, as this is only true in the unique case q=1, it is best to always notate the conjugate of ae^{ti}^{^{q}} as ae^{ti}^{^{−q}}, as is generally done here.

The expression

$${i}^{( 2 p + 1 ) {2}^{2 - m}} ,$$

for integer m, p≥0, appears frequently below. For instance, for m=3, p may be any of 0, 1, 2, and 3, resulting in the values i^{1/2}, i^{3/2}, i^{5/2}, and i^{7/2}, respectively. These values are successive positive (counterclockwise) rotations in the complex plane.

However, since i⁴=i⁻⁴=1, the last two values may be described equivalently as i^{5/2}=i⁻⁴ i^{5/2}=i^{-3/2} and similarly i^{7/2}=i^{-1/2}. Effectively, multiplying by i⁻⁴ converts a positive rotation in the complex plane into an equivalent negative rotation, arriving at the same position in either case. By performing this conversion, it becomes immediately obvious in the sequence i^{1/2}, i^{3/2}, i^{-3/2}, i^{-1/2} that the first and fourth terms are complex conjugates of each other, as are the second and third. This is not as obvious in the original form i^{1/2}, i^{3/2}, i^{5/2}, i^{7/2}.

For display purposes, therefore, in the exemplary matrix entries provided below mixed rotational directions using the above equivalence relationship are shown to highlight conjugates. However, the equations are written with strictly positive rotations in order to always start summations with p=0 for any value of m, which aside from notational simplicity has the advantage that it maps directly onto software data structures for which negative vector or matrix indices are not supported.

The ceiling function (next highest integer) is denoted, as is standard practice, with the [ ] operator: e.g., [0.5]=1.

The cₘₙ coefficients described above provide an equivalent representation of a polynomial P(t) in terms of weights to either the Cairns series functions ψₘₙ(t) or to the equivalent Cairns exponential functions Eₘₙ(t) as described in US664 and ISA-2019 incorporated above.

ψₘₙ(t) and Eₘₙ(t) are asymptotically identical for increasing M: that is, for any input value t, ψₘₙ(t)=Eₘₙ(t) in the limit of large M. The convergence is sufficiently rapid that ψₘₙ(t)=Eₘₙ(t) may be assumed without qualification for most purposes.

As used herein, Eₘₙ(t) are referred to as the multi-spiral representation since as shown below the definition of Eₘₙ(t) involves summing complex spirals

$${e}^{{ti}^{( 2 p + 1 ) {2}^{2 - m}}}$$

across multiple values of p.

It is known to the art that the equations for ψₘₙ and Eₘₙ are:

$${ψ}_{mn} ( t ) = {\sum }_{q = 0}^{∞} {( - 1 )}^{q \cdot ⌈ {2}^{1 - m} ⌉} \cdot \frac{{t}^{q \cdot ⌈ {2}^{m - 1} ⌉ + n}}{( q \cdot ⌈ {2}^{m - 1} ⌉ + n ) !} \qquad ( 7 )$$

$${E}_{mn} ( t ) = \frac{1}{⌈ {2}^{m - 1} ⌉} {\sum }_{p = 0}^{⌈ {2}^{m - 1} ⌉ - 1} {i}^{- n ( 2 p + 1 ) {2}^{2 - m}} {e}^{{ti}^{( 2 p + 1 ) {2}^{2 - m}}} \qquad ( 8 )$$

The value of n is the number of integrations necessary to arrive at a particular ψₘₙ(t) or Eₘₙ(t) from the base (n=0) function ψ_{m,0}(t) or E_{m,0}(t) for the given m-level.

An example of ψₘₙ(t) and Eₘₙ(t) is that the cosine function viewed as a Taylor series is ψ_{2,0}(t), and viewed as a sum of two complex circles is E_{2,0}(t). Similarly, the sine function viewed as a Taylor series is ψ_{2,1}(t) and viewed as a sum of two complex circles is E_{2,1}(t). Further, ψ_{0,0}(t) and E_{0,0}(t) define the rising natural exponential function e^{t} and ψ_{1,0}(t) and E_{1,0}(t) define the decaying natural exponential function e^{-t}.

The equality between the ψₘₙ(t) and Eₘₙ(t) is very useful. As is shown below, the orthogonal pattern of coefficients in the set of all ψₘₙ(t) may be used to project polynomial coefficients cₖ onto the cₘₙ coefficients. Switching to the equivalent Eₘₙ(t) representation then provides geometric information about the polynomial in terms of sums of complex spirals.

Eₘₚ(t) functions each define a single complex spiral that appears in the Eₘₙ(t) multi-spiral sum. Explicitly, for a particular p:

$${E}_{mp} ( t ) = \frac{1}{⌈ {2}^{m - 1} ⌉} {e}^{{ti}^{( 2 p + 1 ) {2}^{2 - m}}} \qquad ( 9 )$$

so that Eₘₚ(t) may be written as:

$${E}_{mn} ( t ) = {\sum }_{p = 0}^{⌈ {2}^{m - 1} ⌉ - 1} {i}^{- n ( 2 p + 1 ) {2}^{2 - m}} {E}_{mp} ( t ) \qquad ( 10 )$$

The transform Q_{mn→mp} finds a set of coefficients cₘₚ applied to the Eₘₚ(t) that is equivalent to the coefficients cₘₙ applied to the Eₘₙ; that is, cₘₚ such that

$${\sum }_{m , p} {c}_{mp} {E}_{mp} ( t ) = {\sum }_{m , n} {c}_{mn} {E}_{mn} ( t ) \qquad ( 11 )$$

### Slow Serial Coefficient Transforms-Runtime Order K\hat{ }2 Overview of Transforms

As discussed above, the below sections define both ‘slow’ (0(K²)) and ‘fast’ (0(K*log (K)) versions of the four transforms Q_{k→mn}, Q_{mn→mp}, Q_{mp→mn} and Q_{mn→k}, but one of ordinary skill will appreciate the benefit of using the fast versions to improve computational speed. While it is possible to normalize the Q_{k→mn} and Q_{mn→mp} transformations, it may be preferable if they are not normalized, for reasons discussed below in regard to delayed normalization.

Slow Transform from cₖ Polynomial to c_{Mn} Multi-Spiral Coefficients

As provided in ISA664 and ISA-2019, transformation from polynomial coefficients cₖ to Cairns or multi-spiral coefficients cₘₙ may be performed using the row orthogonality of the ψₘₙ(t) Cairns series functions, as indicated in the below table for M=3.

TABLE 1
THE CAIRNS SERIES COEFFICIENTS (M = 3)

| | | | t² | t³ | t⁴ | t⁵ | t⁶ | t⁷ | |
|---|---|---|---|---|---|---|---|---|---|
| | 1 | t | 2! | 3! | 4! | 5! | 6! | 7! | . . . |
| ψ_{0,0}(t) = e^{t} | 1 | 1 | 1 | 1 | 1 | 1 | 1 | 1 | . . . |
| ψ_{1,0}(t) = e^{-t} | 1 | −1 | 1 | −1 | 1 | −1 | 1 | −1 | . . . |
| ψ_{2,0}(t) = cos(t) | 1 | 0 | −1 | 0 | 1 | 0 | −1 | 0 | . . . |
| ψ_{2,1}(t) = sin(t) | 0 | 1 | 0 | −1 | 0 | 1 | 0 | −1 | . . . |
| ψ_{3,0}(t) | 1 | 0 | 0 | 0 | −1 | 0 | 0 | 0 | . . . |
| ψ_{3,1}(t) | 0 | 1 | 0 | 0 | 0 | −1 | 0 | 0 | . . . |
| ψ_{3,2}(t) | 0 | 0 | 1 | 0 | 0 | 0 | −1 | 0 | . . . |
| ψ_{3,3}(t) | 0 | 0 | 0 | 1 | 0 | 0 | 0 | −1 | . . . |
| . . . | . . . | . . . | . . . | . . . | . . . | . . . | . . . | . . . | . . . |

An 0(K²) runtime implementation of the transformation Q_{k→mn} may be based on the matrix formed by the coefficients of the ψₘₙ(t) Cairns series functions, as indicated below for M=3 and known to the art.

$${Q}_{k -> mn} = [ \begin{matrix}1 & 1 & 1 & 1 & 1 & 1 & 1 & 1 \\ 1 & - 1 & 1 & - 1 & 1 & - 1 & 1 & - 1 \\ 1 & 0 & - 1 & 0 & 1 & 0 & - 1 & 0 \\ 0 & 1 & 0 & - 1 & 0 & 1 & 0 & - 1 \\ 1 & 0 & 0 & 0 & - 1 & 0 & 0 & 0 \\ 0 & 1 & 0 & 0 & 0 & - 1 & 0 & 0 \\ 0 & 0 & 1 & 0 & 0 & 0 & - 1 & 0 \\ 0 & 0 & 0 & 1 & 0 & 0 & 0 & - 1\end{matrix} ] \qquad ( 12 )$$

If desired, this matrix may be row-normalized to produce Q_{k→mn} by left-multiplying by a scaling matrix which divides each row by its magnitude. The scaling factor depends only on the sum of squares of the entries in each row, which depends only on the row's m-value:

$${s}_{m} = \sqrt{⌈ {2}^{m - 1} ⌉ / {2}^{M}} \qquad ( 13 )$$

For the M=3 case, the normalizing row-scaling matrix is thus:

$${S}_{M} = [ \begin{matrix}1 / ( 2 \sqrt{2} ) & 0 & 0 & 0 & 0 & 0 & 0 & 0 \\ 0 & 1 / ( 2 \sqrt{2} ) & 0 & 0 & 0 & 0 & 0 & 0 \\ 0 & 0 & 1 / 2 & 0 & 0 & 0 & 0 & 0 \\ 0 & 0 & 0 & 1 / 2 & 0 & 0 & 0 & 0 \\ 0 & 0 & 0 & 0 & 1 / \sqrt{2} & 0 & 0 & 0 \\ 0 & 0 & 0 & 0 & 0 & 1 / \sqrt{2} & 0 & 0 \\ 0 & 0 & 0 & 0 & 0 & 0 & 1 / \sqrt{2} & 0 \\ 0 & 0 & 0 & 0 & 0 & 0 & 0 & 1 / \sqrt{2}\end{matrix} ] \qquad ( 14 )$$

The orthonormal transform \hat{Q}_{k→mn} is therefore the result of the matrix multiplication:

$${\hat{Q}}_{k \to mn} = {S}_{M} {Q}_{k \to mn} \qquad ( 15 )$$

which supports the coefficient transform

$${\vec{c}}_{m n} = {\hat{Q}}_{k \to mn} {\vec{c}}_{k} \qquad ( 16 )$$

For instance, for M=3 we have

$$[ \begin{matrix}{c}_{0 , n = 0} \\ {c}_{1 , n = 0} \\ {c}_{2 , n = 0} \\ {c}_{2 , n = 1} \\ {c}_{3 , n = 0} \\ {c}_{3 , n = 1} \\ {c}_{3 , n = 2} \\ {c}_{3 , n = 3}\end{matrix} ] = {\hat{Q}}_{k \to mn} [ \begin{matrix}{c}_{k = 0} \\ {c}_{k = 1} \\ {c}_{k = 2} \\ {c}_{k = 3} \\ {c}_{k = 4} \\ {c}_{k = 5} \\ {c}_{k = 6} \\ {c}_{k = 7}\end{matrix} ] \qquad ( 17 )$$

Slow Transform from cₘₙ Multi-Spiral to cₖ Polynomial Coefficients

The inverse of a real-valued orthonormal matrix is its transpose; therefore

$${\hat{Q}}_{mn \to k} = {\hat{Q}}_{k \to mn}^{T} \qquad ( 18 )$$

so that

$${\vec{c}}_{k} = {\hat{Q}}_{mn \to k} {\vec{c}}_{mn} \qquad ( 19 )$$

In the case of unnormalized transforms Q_{k→mn} and Q_{mn→mp} inversion requires applying the square of the row normalization factor.

Slow Transform from cₘₙ Multi-Spiral to c_{Mp} Unique-Spiral Coefficients

Using the identity ψₘₙ(t)=Eₘₙ(t) given above, the cₘₙ coefficients may be seen as weights to a sum of complex spirals. The value of a polynomial is the summation of all its terms, which is equal to the summation of all of the cₘₙEₘₙ(t) values and may be expressed as:

$$P ( t ) = {\sum }_{k = 0}^{K - 1} {c}_{k} {t}^{k} = {\sum }_{m = 0}^{M} {\sum }_{n = 0}^{N - 1} {c}_{mn} {E}_{mn} ( t ) \qquad ( 20 )$$

The right hand of the above equation may be viewed as a summation across rows formed from the cₘₙEₘₙ(t). For instance, for m=3,

$${\sum }_{n} [ \begin{matrix}{c}_{3 , n = 0} {E}_{3 , n = 0} ( t ) \\ {c}_{3 , n = 1} {E}_{3 , n = 1} ( t ) \\ {c}_{3 , n = 2} {E}_{3 , n = 2} ( t ) \\ {c}_{3 , n = 3} {E}_{3 , n = 3} ( t )\end{matrix} ] = {\sum }_{rows} [ \begin{matrix}{c}_{3 , n = 0} ( {E}_{3 , p = 0} ( t ) + {E}_{3 , p = 1} ( t ) + {E}_{3 , p = 2} ( t ) + {E}_{e , p = 3} ( t ) ) \\ {c}_{3 , n = 1} ( {i}^{- 1 / 2} {E}_{3 , p = 0} ( t ) + {i}^{- 3 / 2} {E}_{3 , p = 1} ( t ) + {i}^{3 / 2} {E}_{3 , p = 2} ( t ) + {i}^{1 / 2} {E}_{e , p = 3} ( t ) ) \\ {c}_{3 , n = 2} ( {i}^{- 1} {E}_{3 , p = 0} ( t ) + i {E}_{3 , p = 1} ( t ) + {i}^{- 1} {E}_{3 , p = 2} ( t ) + i {E}_{e , p = 3} ( t ) ) \\ {c}_{3 , n = 3} ( {i}^{- 3 / 2} {E}_{3 , p = 0} ( t ) + {i}^{- 1 / 2} {E}_{3 , p = 1} ( t ) + {i}^{1 / 2} {E}_{3 , p = 2} ( t ) + {i}^{3 / 2} {E}_{e , p = 3} ( t ) )\end{matrix} ] \qquad ( 21 )$$

$$The summation on the right side may be rearranged to yield = {\sum }_{rows} [ \begin{matrix}( {c}_{3 , n = 0} + {c}_{3 , n = 1} {i}^{- 1 / 2} + {c}_{3 , n = 2} {i}^{- 1} + {c}_{3 , n = 3} {i}^{- 3 / 2} ) {E}_{e , p = 0} ( t ) \\ ( {c}_{3 , n = 0} + {c}_{3 , n = 1} {i}^{- 3 / 2} + {c}_{3 , n = 2} i + {c}_{3 , n = 3} {i}^{- 1 / 2} ) {E}_{e , p = 1} ( t ) \\ ( {c}_{3 , n = 0} + {c}_{3 , n = 1} {i}^{\frac{3}{2}} + {c}_{3 , n = 2} {i}^{- 1} + {c}_{3 , n = 3} {i}^{1 / 2} ) {E}_{e , p = 2} ( t ) \\ ( {c}_{3 , n = 0} + {c}_{3 , n = 1} {i}^{1 / 2} + {c}_{3 , n = 2} i + {c}_{3 , n = 3} {i}^{3 / 2} ) {E}_{e , p = 3} ( t )\end{matrix} ] \qquad ( 22 )$$

The terms in parenthesis define the coefficients cₘₚ of the unique spirals Eₘₚ(t), which may be used to generate a matrix multiplication that transforms from the c_{3,n} to the c_{3,p} coefficients.

$$[ \begin{matrix}{c}_{3 , p = 0} \\ {c}_{3 , p = 1} \\ {c}_{3 , p = 2} \\ {c}_{3 , p = 3}\end{matrix} ] = [ \begin{matrix}1 & {i}^{- 1 / 2} & {i}^{- 1} & {i}^{- 3 / 2} \\ 1 & {i}^{- 3 / 2} & i & {i}^{- 1 / 2} \\ 1 & {i}^{3 / 2} & {i}^{- 1} & {i}^{1 / 2} \\ 1 & {i}^{1 / 2} & i & {i}^{3 / 2}\end{matrix} ] [ \begin{matrix}{c}_{3 , n = 0} \\ {c}_{3 , n = 1} \\ {c}_{3 , n = 2} \\ {c}_{3 , n = 3}\end{matrix} ] \qquad ( 23 )$$

The entries in the above matrix arose from the

$${i}^{- n ( 2 p + 1 ) {2}^{2 - m}}$$

associated with Eₘₙ(t). A direct generalization of the above m=3 case is that for any m-level the transform matrix from cₘₙ to cₘₚ is constructed by forming the matrix in which the p^{th} row, n^{th} column is equal to

$${i}^{- n ( 2 p + 1 ) {2}^{2 - m}}$$

(where row and column indices start from zero). For instance, for the familiar case m=2 (which corresponds to the cosine and sine functions) is

$$[ \begin{matrix}{c}_{2 , p = 0} \\ {c}_{2 , p = 1}\end{matrix} ] = [ \begin{matrix}1 & {i}^{- 1} \\ 1 & i\end{matrix} ] [ \begin{matrix}{c}_{2 , n = 0} \\ {c}_{2 , n = 1}\end{matrix} ] \qquad ( 24 )$$

Giving

$${c}_{2 , n = 0} cos ( t ) = {c}_{2 , n = 0} {E}_{2 , n = 0} ( t ) = {c}_{2 , n = 0} ( {e}^{ti} + {e}^{{ti}^{- 1}} ) / 2 \qquad ( 25 )$$

$$and$$

$${c}_{2 , n = 1} sin ( t ) = {c}_{2 , n = 1} {E}_{2 , n = 1} ( t ) = {c}_{2 , n = 1} ( {e}^{ti} - {e}^{{ti}^{- 1}} ) / ( 2 i ) \qquad ( 26 )$$

$$then {c}_{2 , p = 0} = {c}_{2 , n = 0} + {i}^{- 1} {c}_{2 , n = 1} and {c}_{2 , p = 1} = {c}_{2 , n = 0} + i {c}_{2 , n = 1} , which yields {c}_{2 , p = 0} {E}_{2 , p = 0} ( t ) = {c}_{2 , p = 0} {e}^{ti} / 2 \qquad ( 27 )$$

$$and$$

$${c}_{2 , p = 1} {E}_{2 , p = 1} ( t ) = {c}_{2 , p = 1} {e}^{{ti}^{- 1}} / 2 \qquad ( 28 )$$

which is equivalent to the starting c_{2,n} representation, as may be checked by observing that the corresponding sums are equal:

$$\frac{{c}_{2 , n = 0} ( {e}^{it} + {e}^{{ti}^{- 1}} )}{2} + \frac{{c}_{2 , n = 1} ( {e}^{it} - {e}^{{ti}^{- 1}} )}{2 i} = \frac{{c}_{2 , p = 0} {e}^{ti}}{2} + \frac{{c}_{2 , p = 1} {e}^{{ti}^{- 1}}}{2} \qquad ( 29 )$$

One of ordinary skill may then build the transform Q_{mn→mp} for all values of m by assembling a block diagonal matrix from the matrices at each m-level yielding a single matrix which performs the transformation Q_{mn→mp}. For instance, for M=3, and therefore 0≤m≤M, the transform is:

$${Q}_{mn \to mp} = [ \begin{matrix}1 & 0 & 0 & 0 & 0 & 0 & 0 & 0 \\ 0 & 1 & 0 & 0 & 0 & 0 & 0 & 0 \\ 0 & 0 & 1 & {i}^{- 1} & 0 & 0 & 0 & 0 \\ 0 & 0 & 1 & i & 0 & 0 & 0 & 0 \\ 0 & 0 & 0 & 0 & 1 & {i}^{- \frac{1}{2}} & {i}^{- 1} & {i}^{\frac{- 3}{2}} \\ 0 & 0 & 0 & 0 & 1 & {i}^{\frac{- 3}{2}} & i & {i}^{- \frac{1}{2}} \\ 0 & 0 & 0 & 0 & 1 & {i}^{\frac{3}{2}} & {i}^{- 1} & {i}^{\frac{1}{2}} \\ 0 & 0 & 0 & 0 & 1 & {i}^{\frac{1}{2}} & i & {i}^{\frac{3}{2}}\end{matrix} ] \qquad ( 30 )$$

with

$$[ \begin{matrix}{c}_{0 , p = 0} \\ {c}_{1 , p = 0} \\ {c}_{2 , p = 0} \\ {c}_{2 , p = 1} \\ {c}_{3 , p = 0} \\ {c}_{3 , p = 1} \\ {c}_{3 , p = 2} \\ {c}_{3 , p = 3}\end{matrix} ] = {Q}_{m \leq 3 , n \to m \leq 3 , p} [ \begin{matrix}{c}_{0 , n = 0} \\ {c}_{1 , n = 0} \\ {c}_{2 , n = 0} \\ {c}_{2 , n = 1} \\ {c}_{3 , n = 0} \\ {c}_{3 , n = 1} \\ {c}_{3 , n = 2} \\ {c}_{3 , n = 3}\end{matrix} ] \qquad ( 31 )$$

The general case is

$${\vec{c}}_{mp} = {Q}_{mn \to mp} {\vec{c}}_{mn} \qquad ( 32 )$$

The rows of Q_{mn→mp} are orthogonal, but are not normalized: that is, their row lengths (root mean square value) are not equal to one. Therefore, the Q_{mn→mp} matrix is orthogonal but not orthonormal. The reason for this will be discussed with regard to delayed normalization.

Slow Transform from cₘₚ Unique-Spiral to c_{Mn} Multi-Spiral Coefficients

Given the orthogonal matrix transformation Q_{mn→mp} detailed above, it is known to the art that the inverse transformation Q_{mp→mn} must be a scaled version of the Hermitian (complex conjugate transpose) of Q_{mn→mp}, denoted by

$${Q}_{mn \to mp}^{†} .$$

If Q_{mn→mp} was orthonormal, then the scaling factor would be simply the identity matrix I. However, as discussed above, Q_{mn→mp} is not orthonormal. Therefore, Q_{mp→mn} must be scaled by a diagonal matrix D, such that the inversion condition holds. That is,

$${Q}_{mp \to mn} = {DQ}_{mn \to mp}^{†}$$

such that

$$D {Q}_{mn \to mp}^{†} {Q}_{mn \to mp} = I \qquad ( 33 )$$

Using techniques known to the art, the scaling matrix D may be formed from the factor

$$\frac{1}{⌈ {2}^{m - 1} ⌉} ,$$

for m≤M. Given this definition of Q_{mp→mn}, then

$${\vec{c}}_{mn} = {Q}_{mp \to mn} {\vec{c}}_{mp} \qquad ( 34 )$$

### Composite Transforms

As is known, linear transformations represented by matrices may be composed by matrix multiplication in order to produce a single combined linear transformation. For instance, the M=3 matrix transformations given above may be multiplied to provide the transformation

$${Q}_{k \to mp} = {Q}_{mn \to mp} {Q}_{k \to mn} = [ \begin{matrix}1 & 1 & 1 & 1 & 1 & 1 & 1 & 1 \\ 1 & - 1 & 1 & - 1 & 1 & - 1 & 1 & - 1 \\ 1 & - i & - 1 & i & 1 & - i & - 1 & 1 \\ 1 & i & - 1 & - i & 1 & i & - 1 & - 1 \\ 1 & {i}^{- \frac{1}{2}} & - i & {i}^{\frac{- 3}{2}} & - 1 & {i}^{\frac{3}{2}} & 1 & {i}^{\frac{1}{2}} \\ 1 & {i}^{\frac{- 3}{2}} & i & {i}^{- \frac{1}{2}} & - 1 & {i}^{\frac{1}{2}} & - 1 & {i}^{\frac{3}{2}} \\ 1 & {i}^{\frac{3}{2}} & - i & {i}^{\frac{1}{2}} & - 1 & {i}^{- \frac{1}{2}} & i & {i}^{\frac{- 3}{2}} \\ 1 & {i}^{\frac{1}{2}} & i & {i}^{\frac{3}{2}} & - 1 & {i}^{\frac{3}{2}} & - i & {i}^{- \frac{1}{2}}\end{matrix} ] \qquad ( 35 )$$

### Fast Serial Coefficient Transforms-Runtime Order K*Log (K)

The previous section gave implementations for the coefficient transformations in terms of matrix multiplication, which has a runtime that is 0(K²) in the number of polynomial terms K. This section introduces for each transformation an equivalent much faster algorithm that has 0 (K*log (K)) runtime.

Fast Transform from cₖ Polynomial to c_{Mn} Multi-Spiral Coefficients

The matrix transformation Q_{k→mn} given previously has a number of non-zero entries per row which is reduced by a factor of two with each successive increment of m. The implication is that the number of non-zero entries in the matrix as a whole is 0(K*log (K)). Converting the matrix multiplication 0(K²) version of Q_{k→mn} into an equivalent 0(K*log (K)) algorithm may be performed by including only the non-zero matrix entries of Q_{k→mn} in the calculation, which may be done by introducing an indexing scheme that “steps over” the zeros.

Referring to the matrix version of the Q_{k→mn} transform given previously and repeated below, the necessary indexing scheme may be achieved by processing each m-level individually, keeping mind that the non-zero entries are separated by a ‘step-size’ of [2^{m-1}]. Thus, for the first row we have m=0 and therefore the step-size is one ([2^{m-1}]=[2⁻¹]=[0.5]=1), indicating that all entries in the row are non-zero.

The same is true for the second row, corresponding to m=1, for which the step-size is [2^{m-1}]=[2¹⁻¹]=[2⁰]=[1]=1. For the third and fourth rows, m=2 and the step-size is 2²⁻¹=2, indicating two columns from one non-zero entry to the next. For the fourth through eighth rows m=3, and the step-size is 4.

Note also that for m≥2, there are multiple rows for the given m-value with non-zero entries offset by one column per successive row.

$${Q}_{k \to mn} = [ \begin{matrix}1 & 1 & 1 & 1 & 1 & 1 & 1 & 1 \\ 1 & - 1 & 1 & - 1 & 1 & - 1 & 1 & - 1 \\ 1 & 0 & - 1 & 0 & - 1 & 0 & 1 & 0 \\ 0 & 1 & 0 & - 1 & 0 & 1 & 0 & - 1 \\ 1 & 0 & 0 & 0 & - 1 & 0 & 0 & 0 \\ 0 & 1 & 0 & 0 & 0 & - 1 & 0 & 0 \\ 0 & 0 & 1 & 0 & 0 & 0 & - 1 & 0 \\ 0 & 0 & 0 & 1 & 0 & 0 & 0 & - 1\end{matrix} ] \qquad ( 36 )$$

With this Q_{k→mn} matrix non-zero entry pattern, the matrix transform [symbol] ₘₙ=Q_{k→mn} [symbol] ₖ may be reduced to 0(K*log (K)) multiplies.

Fast Transform from cₘₙ Multi-Spiral to cₖ Polynomial Coefficients

As shown above, the matrix representation of Q_{mn→k} is the normalized transpose of the matrix representation of Q_{k→mn}. The Q_{mn→k} matrix therefore, like the Q_{k→mn} matrix, has only 0 (K*log (K)) non-zero entries, and may therefore be reduced to an algorithm with 0(K*log (K)) multiplications by means similar to the Q_{k→mn} case, as will be apparent to practitioners.

Fast Transform from cₘₙ Multi-Spiral to c_{Mp} Unique-Spiral Coefficients

For the Q_{k→mn} transformation, the matrix implementation is sparse. As such, an 0(K*log (K)) implementation may be created by avoiding calculations associated with the zeroes in the matrix. The matrix version of Q_{mn→mp} is not sparse. For rows corresponding to m=M, exactly half of the entries in each row are non-zero, meaning that the number of non-zero entries in the matrix is proportional to the size of the matrix and therefore is 0(K²).

Reducing Q_{mn→mp} to an 0(K*log (K)) algorithm therefore requires not simply avoiding zeros, but instead exploiting patterns in the matrix version of O_{mn→mp} in order to reduce the number of computations. In particular, the 0(K*log (K)) algorithm introduced below takes advantage of reflective symmetries.

An example of reflective symmetries is provided for the M=3 version of the Q_{mn→mp} matrix

$${Q}_{mn \to mp} = [ \begin{matrix}1 & 0 & 0 & 0 & 0 & 0 & 0 & 0 \\ 0 & 1 & 0 & 0 & 0 & 0 & 0 & 0 \\ 0 & 0 & 1 & {i}^{- 1} & 0 & 0 & 0 & 0 \\ 0 & 0 & 1 & i & 0 & 0 & 0 & 0 \\ 0 & 0 & 0 & 0 & 1 & {i}^{- \frac{1}{2}} & {i}^{- 1} & {i}^{- \frac{3}{2}} \\ 0 & 0 & 0 & 0 & 1 & {i}^{- \frac{3}{2}} & i & {i}^{- \frac{1}{2}} \\ 0 & 0 & 0 & 0 & 1 & {i}^{\frac{3}{2}} & {i}^{- 1} & {i}^{\frac{1}{2}} \\ 0 & 0 & 0 & 0 & 1 & {i}^{\frac{1}{2}} & i & {i}^{\frac{3}{2}}\end{matrix} ] \qquad ( 37 )$$

Consider the m=M=3 entries (the bottom right 4×4 values in the matrix). Matching rows from inside out, the bottom rows are the complex conjugates of the corresponding top rows, and equivalently, reflections of each other across the positive real axis, which may be denoted i⁰=1.

Extending to M=4 and for conciseness showing only the non-zero m=M matrix entries (corresponding to the bottom right of the Q_{mn→mp} matrix), we have:

$${Q}_{4 , n \to 4 , p} = [ \begin{matrix}1 & {i}^{- \frac{1}{4}} & {i}^{- \frac{1}{2}} & {i}^{- \frac{3}{4}} & {i}^{- 1} & {i}^{- \frac{5}{4}} & {i}^{- \frac{3}{2}} & {i}^{- \frac{7}{4}} \\ 1 & {i}^{\frac{- 3}{4}} & {i}^{- \frac{3}{2}} & {i}^{\frac{7}{4}} & i & {i}^{\frac{1}{4}} & {i}^{- \frac{1}{2}} & {i}^{- \frac{5}{4}} \\ 1 & {i}^{\frac{- 5}{4}} & {i}^{\frac{3}{2}} & {i}^{\frac{1}{4}} & {i}^{- 1} & {i}^{\frac{7}{4}} & {i}^{\frac{1}{2}} & {i}^{- \frac{3}{4}} \\ 1 & {i}^{\frac{- 7}{4}} & {i}^{\frac{1}{2}} & {i}^{- \frac{5}{4}} & i & {i}^{- \frac{3}{4}} & {i}^{\frac{3}{2}} & {i}^{- \frac{1}{4}} \\ 1 & {i}^{\frac{7}{4}} & {i}^{- \frac{1}{2}} & {i}^{\frac{5}{4}} & {i}^{- 1} & {i}^{\frac{3}{4}} & {i}^{- \frac{3}{2}} & {i}^{\frac{1}{4}} \\ 1 & {i}^{\frac{5}{4}} & {i}^{- \frac{3}{2}} & {i}^{- \frac{1}{4}} & i & {i}^{- \frac{7}{4}} & {i}^{- \frac{1}{2}} & {i}^{\frac{3}{4}} \\ 1 & {i}^{\frac{3}{4}} & {i}^{\frac{3}{2}} & {i}^{- \frac{7}{4}} & {i}^{- 1} & {i}^{- \frac{1}{4}} & {i}^{\frac{1}{2}} & {i}^{\frac{5}{4}} \\ 1 & {i}^{\frac{1}{4}} & {i}^{\frac{1}{2}} & {i}^{\frac{3}{4}} & i & {i}^{\frac{5}{4}} & {i}^{\frac{3}{2}} & {i}^{\frac{7}{4}}\end{matrix} ] \qquad ( 38 )$$

The skilled artisan will note that in the first matrix row above, entries that are separated by half the number of columns are equal if the first is multiplied by a factor i⁻¹, i.e.,

$$1 {i}^{- 1} = {i}^{- 1} ; {i}^{- \frac{1}{4}} {i}^{- 1} = {i}^{- \frac{5}{4}} ; {i}^{- \frac{1}{2}} {i}^{- 1} = {i}^{- \frac{3}{2}} ; {i}^{- \frac{3}{4}} {i}^{- 1} = {i}^{- \frac{7}{4}} .$$

This pattern holds on the top row of all Q_{mn→mp} matrices for m≥2, m=2 being the first case that has more than one column. It is known to the art that a separation by a factor of i⁻¹ corresponds to an angular separation in the complex plane of −π/2, indicating that the elements of each pair are orthogonal to each other. This fact will be important later in the inverse fast algorithm mapping back from the cₘₚ to the cₘₙ coefficients.

Matching the rows of the above matrix inside out, the bottom rows are the complex conjugates of the top rows (i.e., matching rows may be obtained from each other by reversing the sign in the exponent of i). This indicates that we do not have to compute the effect of Q_{3,n→3,p} when multiplied by cₘₙ for both the top and bottom half of the rows. The top rows may be computed and then the equivalent sum for the matching bottom half row may be found by conjugation. This operation produces a factor of two improvement in runtime, but is nonetheless still an 0(K²) algorithm.

The operations may be further reduced to 0(K*log (K)) by applying the idea of reflections iteratively on the Q_{mn→mp} matrix. The number of operations may be reduced by reflecting partial summations rather than individual coefficients. The partial summations are refined to the final answer (cₘₚ coefficients) in a logarithm number of stages, with a linear number of operations at each stage, resulting in an 0(K*log (K)) runtime.

The reflective symmetries from the top row down (as this leads naturally to the fast Q_{mn→mp} algorithm), in the above Q_{mn→mp} matrix are:
The 1^{st} (top) and 2^{nd} rows correspond through a sum of four reflections. Explicitly, between the two rows, the first (left-most) and fifth column entries are related between the two rows by reflection across the real axis; the second and sixth column entries are related by reflection across the i^{-1/2} axis; the third and seventh entries are related by reflection across the i⁻¹ axis; and the fourth and eighth entries are related by reflection across the i^{-3/2} axis.
The 1^{st} and 4^{th} rows are related through a sum of two reflections. The first, third, fifth and seventh entries are related by reflection across the real axis, i⁰. The second, fourth, sixth and eighth entries are related by reflection across the negative imaginary axis, i⁻¹. The same relations hold between the 2^{nd} and 3^{rd} rows.
The 1^{st} and 8^{th} rows are related by reflection across a single axis, the real axis i⁰, for all entries. The same relations hold between the 2^{nd} and 7^{th} rows; the 3^{rd} and 6^{th} rows; and the 4^{th} and 5^{th} rows.

Reflective symmetries may be used to avoid repeating summations in matched rows that would give equivalent (under reflection) results by employing the following stages with an exemplary m=4 case, which is more generally described below.
Stage 1: Top Row. Calculate the product of each of the coefficients of c_{4,n} with the corresponding entry in the 1^{st} row of the Q_{4,n→4,p} to yield a vector with entries

$$[ {c}_{4 , 0} , {c}_{4 , 1} {i}^{- \frac{1}{4}} , {c}_{4 , 2} {i}^{\frac{- 1}{2}} , {c}_{4 , 3} {i}^{- 3 / 4} , {c}_{4 , 4} {i}^{- 1} , {c}_{4 , 5} {i}^{- 5 / 4} , {c}_{4 , 6} {i}^{- 3 / 2} , {c}_{4 , 7} {i}^{- 7 / 4} ] .$$

At this stage, the coefficients are neither summed nor reflected.
Stage 2 Top two rows. Corresponding to the reflective symmetries between the 1^{st} and 2^{nd} rows as given above, form four sums: of the first and fifth entries of the vector resulting from Stage 1; of the second and sixth entries; of the third and seventh entries; and of the fourth and eight entries. Keep these summations associated with the 1^{st} row. Reflect each of these summed values across the corresponding complex axis between rows 1 and 2 and store the four reflected values in association with row 2.
Stage 3: Top four rows. In each of rows 1 and 2, add the first and third summations and the second and fourth summations to get the new first and second summations. Using the reflection axes defined above, reflect the resulting sums from row 1 into row 4, and from row 2 into row 3.
Stage 4: All eight rows. For all of rows 1 through 4, add the two associated summations to produce a single sum (coefficient) for each row. This is the cₘₚ coefficient for each of these rows respectively. Take the conjugate of each of these values and assign the conjugate from row 1 to row 8; from row 2 to row 7; from row 3 to row 6; and from row 4 to row 5. These are the cₘₚ coefficients for rows 5 through row 8, completing the transform from cₘₙ to cₘₚ coefficients.

The generalization of this algorithm to any value of m proceeds as follows:
The number of initial rows is [2^{m-1}].
The number of initial axes of reflection, num_axes, is [2^{m-2}]. Each axis of reflection is a unit vector in the complex plane. The first axis of reflection is i⁰ (the real axis). The angular separation between adjacent axes of reflection is −π/num_axes.
The generalized algorithm always starts with the top-most row, as with the m=4 case detailed above.
After each stage at the current m-level, the number of active rows is doubled, always including only the top-most rows, stopping when all rows have been processed.
After each stage, the number of reflection axes is reduced by half, by removing the second and subsequent even-numbered axes. (Equivalently, a new set of reflection axes may be created by doubling the angular separation in the range 0 t−π.)
The active rows are paired from the middle two (or only) rows outward.
In each stage, a number of sums is computed in each of the top half the rows that is equal to the number of reflection axes. Each of these sums is reflected to its paired bottom row using the corresponding reflection axis.

The reflection of a sum (which in general is a complex number) across a reflection axis may be found by means known to the art.

Exemplary MATLAB code implementing the fast Q_{mn→mp} algorithm is provided below.
The support function mn_to_row_index(m,n) returns the index into the [symbol] ₘₙ vector corresponding to the given m and n.
The support function mp(m,p) returns (2p+1) 2^{2-m}.

The support function reflection (vec, axis) reflects the complex vector vec across the complex vector axis.
The statement reflect_angles=[0: angle_incr:pi-angle_incr] in MATLAB notation stores into the variable reflect_angles the sequence of angles starting at zero, incrementing by angle_incr, and including all angles less than n-angle_incr.
In the statement reflect_axes=exp (−li.*reflect_angles); the operator.*in MATLAB notation means “multiply by every element in the sequence”. Therefore, the variable reflect_axes is set equal to the sequence of values e^{-i*angle} for every angle in reflect_angles.

```
    % Over all m-levels
    for m = 0:M
      %% Collect data for this m-level
      % Maximum n and p values for this m-level. (n_max and p_max are
      % always equal, but it is useful to label them separately to
      % indicate whether n or p is at issue at a given point.)
      n_max=ceil(2\hat{ }(m-1))-1;
      p_max=ceil(2\hat{ }(m-1))-1;
    % Input Cmn values for this m-level
    beg_idx = mn_to_row_index(m,0);
    end_idx = mn_to_row_index(m,n_max);
    this_Cmn = Cmn(beg_idx:end_idx);
    % Array to hold sums of reflection data. (Only p_max*log(p_max) of
    % the entries will be used, so this could be made more memory
    % efficient, but it is clearer as is to show the algorithm.)
    pn_data = zeros(p_max+1,n_max+1);
    % All reflection axes that will be used
    num_axes = ceil(2\hat{ }(m-2));
    angle_incr = pi/num_axes;
    reflect_angles = [0:angle_incr:pi-angle_incr];
    reflect_axes  = exp(-1i.*reflect_angles);
    %% Start by filling the top-most p-value row (p=0)
    % (Note the eternal nuisance that MATLAB array indices start at
    % 1, not 0, hence indices 1 for p=0 and n+1 for n.)
    m0_f = mp(m,0);
    for n = 0:n_max
        imag_coeff = 1i\hat{ }(-n*m0_f);
        pn_data(1,n+1) = this_Cmn(n+1)*imag_coeff;
    end
    %% Iterate over doubling number of p-value rows
    num_rows = 2;
    while num_rows <= p_max+1
      % Iterate over matching pairs of p-value rows inside-out
      p_top = num_rows/2-1;
      p_bot = num_rows/2;
      while p_top >= 0
        % Sum values with the same relection axis in the top row
        % and reflect to the bottom row
        step_size = num_axes;
        for n = 0:length(reflect_axes) -1
          % Sum values in top row with same reflection axis
          top_Cnp = pn_data(p_top+1,n+1) + ...
              pn_data(p_top+1,n+1+step_size);
          pn_data(p_top+1,n+1) = top_Cnp;
          % Complex axis of reflection
          this_axis = reflect_axes(n+1);
          % Reflect into bottom row
          pn_data(p_bot+1,n+1) = reflection(top_Cnp,this_axis);
        end
        % On to next pair of p-value rows
        p_top = p_top-1;
        p_bot = p_bot+1;
      end
      % Prepare for next iteration, expanding downward in rows. The
      % number of rows doubles, the number of reflection axes halves.
      num_rows  = 2*num_rows;
      indices = 1:2:length(reflect_axes);
      reflect_axes = reflect_axes(indices);
      num_axes = length(reflect_axes);
    end
    %% The left-most column of np_data holds the Cmp coefficients
    Cmp(beg_idx:end_idx) = pn_data(1:end,1);
end
```

Fast Transform from cₘₚ Unique-Spiral to c_{Mn} Multi-Spiral Coefficients

A fast (0(K*log (K)) Q_{mp→mn} transform may be created by inverting the operations of the fast Q_{mn→mp} transform. As noted above, the fast Q_{mn→mp} transform operates by forming sums and then reflecting the sums into other rows. The fast Q_{mp→mn} transform must therefore reverse the reflections, then decompose the reflected sums into their parts. A difficulty is that addition of course is not by itself an invertible operation. For instance, if we know only that 4 is the result of a sum, we do not know if it arose from 2+2 or 1+3 or 0+4, not to mention possible real-valued components.

A key aspect underlying the fast Q_{mp→mn} algorithm is to exploit the combined geometry of two reflections in order to unambiguously decompose summations. The components of each summation are reflected across different axes, and by combining this information the components may be unambiguously determined. An important point is that in the fast Q_{mn→mp} transform, at each stage reflections are always from the top half of the currently active rows to the paired bottom half of the currently active rows. Summations in the top half of the rows are not affected by reflection. In the subsequent stage, what were the bottom half of the rows in the previous stage become part of the top half of the rows, and therefore their summations will never again be affected by reflection. This gives us a history of summations with and without reflection.

To see how this information may be used in detail, consider a sequence of actions in the fast Q_{mn→mp} transform, which it is the task of the fast Q_{mn→mp} algorithm to reverse. Follow what happens in two paired rows rₜ (a ‘top’ row) and r_{b} (a ‘bottom’ row below it) in three steps. Step 1: Prior to reflection from rₜ to r_{b}.

| | | | | | | | | |
|---|---|---|---|---|---|---|---|---|
| ᵣₜ | w | . . . | x | . . . | y | . . . | z | |
| . . . | | | | | | | | |
| r_{b} | | . . . | | . . . | | . . . | | . . . |

rₜ contains a set of values that will be summed and reflected into the paired row r_{b}. Step 2: During reflection from rₜ to r_{b}.

| | | | | |
|---|---|---|---|---|
| rₜ | A = w + y | . . . | B = x + z | . . . |
| . . . | | | | |
| r_{b} | A′ | . . . | B′ | . . . |

Sums A and B are created in row rₜ. These sums are reflected into rₜ across the axes a₀ and a₁, respectively, which as described above are unit vectors in the complex plane. The reflections A′ and B′ are placed in r_{b}.

Step 3: r_{b} is now part of the top half of the active rows and rₜ and r_{b} both reflect sums into the top rows of the next larger grouping.

| | | |
|---|---|---|
| rₜ | C = A + B | . . . |
| . . . | | |
| r_{b} | C′ = A′ + B′ | . . . |

In the fast Q_{mp→mn} transform the key task is to reverse these steps. Knowing C and C′, and the reflection axes a, and a₁, A and B may be iteratively determined to transform from the cₘₚ to the cₘₙ coefficients. It is possible to solve for A and B, given C, C′, a₀ and a₁. (The values A′ and B′ may also be determined but are not needed to execute the fast Q_{mp→mn} transform.)

A and A′ are points in the complex plane that have the same magnitude, k_{A}. They have opposite reflection angles with respect to a₀, which we will call δ₄ and −δ₄, respectively. For B and B′ we similarly have k_{B}, δ_{B} and −δ_{B}. Take θ₀, and θ₁ to be the angles of axis a₀ and a₁ in the complex plane. Then we start with:

$$A = {k}_{A} {e}^{i ( {θ}_{0} + {δ}_{A} )} \qquad ( 39 )$$

$$B = {k}_{B} {e}^{i ( {θ}_{1} + {δ}_{B} )} \qquad ( 40 )$$

$${A}^{′} = {k}_{A} {e}^{i ( {θ}_{0} - {δ}_{A} )} \qquad ( 41 )$$

$${B}^{′} = {k}_{B} {e}^{i ( {θ}_{1} - {δ}_{B} )} \qquad ( 42 )$$

There are four real-valued unknowns, K_{A}, k_{B}, δ_{A} and δ_{B}, and two complex known values, C and C′, each of which has real and imaginary components, for a total of four known values from which a solvable system of equations may be formed:

$$C = A + B = {k}_{A} {e}^{i ( {θ}_{0} + {δ}_{A} )} + {k}_{B} {e}^{i ( {θ}_{1} + {δ}_{B} )} \qquad ( 43 )$$

$$and$$

$${C}^{′} = {A}^{′} + {B}^{′} = {k}_{A} {e}^{i ( {θ}_{0} - {δ}_{A} )} + {k}_{B} {e}^{i ( {θ}_{1} - {δ}_{B} )} \qquad ( 44 )$$

Combining the unknown magnitudes with the unknown angles gives:

$${?}_{A} = {k}_{A} {e}^{i {δ}_{A}} \qquad ( 45 )$$

$$and$$

$${?}_{B} = {k}_{B} {e}^{i {δ}_{B}} \qquad ( 46 )$$

$$with conjugates$$

$${{?}_{A}}^{′} = {k}_{A} {e}^{- i {δ}_{A}} \qquad ( 47 )$$

$$and$$

$${{?}_{B}}^{′} = {k}_{A} {e}^{- i {δ}_{B}} \qquad ( 48 )$$

$$so that$$

$$A = {?}_{A} {e}^{i {θ}_{0}} \qquad ( 49 )$$

$$B = {?}_{B} {e}^{i {θ}_{1}} \qquad ( 50 )$$

$${A}^{′} = {{?}_{A}}^{′} {e}^{i {θ}_{0}} \qquad ( 51 )$$

$${B}^{′} = {{?}_{B}}^{′} {e}^{i {θ}_{1}} \qquad ( 52 )$$

Equations for C and C′ are then

$$C = A + B = {?}_{A} {e}^{i {θ}_{0}} + {?}_{B} {e}^{i {θ}_{1}} \qquad ( 53 )$$

$$and$$

$${C}^{′} = {A}^{′} + {B}^{′} = {{?}_{A}}^{′} {e}^{i {θ}_{0}} + {{?}_{B}}^{′} {e}^{i {θ}_{1}} \qquad ( 54 )$$

These equations may be solved for ?_{A} and ?_{B}. After minor adventures, we find

$${?}_{A} = conj ( ( {C}^{′} - conj ( {?}_{B} ) {e}^{i {θ}_{1}} ) {e}^{- i {θ}_{0}} ) \qquad ( 55 )$$

$${?}_{B} = ( C - conj ( {C}^{′} ) {e}^{i 2 {θ}_{0}} ) / ( {e}^{i {θ}_{1}} - {e}^{i ( 2 * {θ}_{0} - {θ}_{1} )} ) \qquad ( 56 )$$

where conj is the standard conjugation function.

A and B are now fully determined as

$$A = {?}_{A} {e}^{i {θ}_{0}} \qquad ( 57 )$$

$$B = {?}_{B} {e}^{i {θ}_{1}} \qquad ( 58 )$$

The main part of the fast Q_{mp→mn} algorithm involves applying the above equations to find A and B, which are then unwound in turn to find their component sums.

At the final stage we have only the top row left, with K/2 summations of two terms each. As discussed above in the context of the fast Q_{mn→mp} transform, these sums are the result of adding two orthogonal complex values with known axes, and therefore the sums in the top row may be decomposed by orthogonal projection. This results in the output cₘₙ coefficients.

Exemplary MATLAB code implementing the fast Q_{mp→mn} algorithm is provided below.

| % Over all m-levels | |
|---|---|
| for m = 0:M | |
| %% Collect data for this m-level | |
| % Maximum n and p values for this m-level. (n_max and p_max are | |
| % always equal, but it is useful to label them separately to | |
| % indicate whether n or p is at issue at a given point.) | |
| n_max = ceil(2\hat{ }(m-1))-1; | |
| p_max = ceil(2\hat{ }(m-1))-1; | |
| % Input Cmp coefficients for this m-level | |
| beg_idx = mn_to_row_index(m,0); | |
| end_idx = mn_to_row_index(m,n_max); | |
| this_Cmp = Cmp(beg_idx:end_idx); | |
| % Array to hold Cmp values that we will iterative de-sum. (Only | |
| % n_max*log(n_max) of the entries will be used, so this could be | |
| % made more memory efficient, but it is clearer as is to show the | |
| % algorithm.) | |
| % | |
| % Conceptually, we are reversing the Cmn -> Cmp map, so as in that | |
| % algorithm we think of ‘p’ defining the rows and 'n' the columns. | |
| pn_data = zeros(p_max+1,n_max+1); | |
| pn_data(:,1) = this_Cmp; | |
| %% Iterate over halving number of p-value rows | |
| num_top_rows = (p_max+1)/2; | |
| num_axes = 2; | |
| n_step = 1; % n (column) distance between sub-sums of current sum | |
| while num_top_rows > 1 | |
| % Reflection axes for this set of rows | |
| angle_incr = pi/num_axes; | |
| reflect_angles = [0:angle_incr:pi-angle_incr]; | |
| reflect_axes = exp(-1i.*reflect_angles); | |
| %% Iterate over matching pairs of p-value rows inside-out | |
| p_top = num_top_rows/2 -1; | |
| p_bot = num_top_rows/2; | |
| while p_top >= 0 | |
| % Unwind sums on this row | |
| n = 0; | |
| while n < n_step | |
| % Get data | |
| axis0 = reflect_axes(n +1); | |
| axis1 = reflect_axes(n+n_step+1); | |
| theta0 = angle(axis0); | |
| theta1 = angle(axis1); | |
| C = pn_data(p_top+1, n+1); | |
| Cprime = pn_data(p_bot+1, n+1); | |
| % Top row values (bottom are not needed) | |
| Q_B = (C - conj(Cprime)*exp(1i*2*theta0)) / ... | |
| (exp(1i*theta1) - exp(li*(2*theta0-theta1))); | |
| Q_A = conj((Cprime - conj(Q_B)*exp(li*theta1))* ... | |
| exp(-1i*theta0)); | |
| A = Q_A*exp(1i*theta0); | |
| B = Q_B*exp(1i*theta1); | |
| % Save results | |
| pn_data(p_top+1, n+1 ) = A; | |
| pn_data(p_top+1, n+n_step+1) = B; | |
| % Onward across row | |
| n = n+1; | |
| end | |
| p_top = p_top-1; | |
| p_bot = p_bot+1; | |
| end | |
| % Onward to next set of rows | |
| num_axes = 2*num_axes; | |
| n_step = 2*n_step; | |
| num_top_rows = num_top_rows/2; | |
| end | |
| %% Handle top row | |
| % Use the orthogonality of the axes pairs within the top row to | |
| % separate sums of two coefficients by projection | |
| p = 0; | |
| n = 0; | |
| n_step = (n_max+1)/2; | |
| while n+n_step <= n_max | |
| % Current value in p=0 row to be de-summed | |
| C = pn_data(p+1,n+1); | |
| % Project C and insert components back into p=0 row | |
| mp_f | = mp(m,p); |
| axis0 | = 1i\hat{ }(-n *mp_f); |
| axis1 | = 1i\hat{ }(-(n+n_step)*mp_f); |
| theta0 | = angle(axis0); |
| theta1 | = angle(axis1); |
| [A,B] | = projection(C,axis0,axis1); |
| pn_data(p+1, n+1) | = A; |

```
    pn_data(p+1,n+n_step+1) = B;
    n = n+1;
    if abs(theta0 - thetal) - pi/2 > 0.000001
      error(‘Should be orthogonal’);
    end
  end
  %% Record results for this m-level
  % Remove Cmp imaginary integration coefficients to get real-valued
  % Cmn coefficients
  num_axes  = n_max+1;
  angle_incr = pi/num_axes;
  all_angles = [0:angle_incr:pi-angle_incr];
  all_axes = exp(1i.*all_angles);
  Cmn(beg_idx:end_idx) = pn_data(1,1:end) .* all_axes;
end
% Results should be real (assuming here real-valued input polynomial
% coefficients), check this then remove imaginary round-off error
test = rms(imag(Cmn))/rms(real(Cmn));
if test > 0.000001
  error(‘Should be real’);
end
Cmn = real(Cmn)
```

### Delayed Normalization

For simplicity, the normalization discussion here is in terms of the slow (matrix) versions of the transformations introduced above, although equivalent issues apply to the fast versions of the transformations and may be addressed using techniques known to the art.

It was shown above with reference to the transformation from cₖ polynomial coefficients to the cₘₙ multi-spiral coefficients that the orthogonal but unnormalized matrix transform Q_{k→mn} may be row-normalized by multiplying by a diagonal scaling matrix S_{M}: that is, Q_{k→mn}=S_{M}Q_{k→mn}, where Q_{k→mn} is orthonormal.

Including the unique-spiral operations to be introduced below, our high-level process with normalization has the following stages:
Stage 1: Transform from cₖ polynomial coefficients to cₘₙ multi-spiral coefficients using the matrix multiplication [symbol] ₘₙ=\hat{Q}_{k→mn} [symbol] ₖ.
Stage 2: Transform from cₘₙ multi-spiral coefficients to cₘₚ unique-spiral coefficients using the matrix multiplication [symbol] ₘₚ=\hat{Q}_{mn→mp} [symbol] ₘₙ.
Stage 3: Perform operations in the unique-spiral representation, as detailed in following sections.
Stage 4: Transform back from cₘₚ unique-spiral coefficients to cₘₙ multi-spiral coefficients using the matrix multiplication [symbol] ₘₙ=\hat{Q}_{mp→mn} [symbol] ₘₚ.
Stage 5: Transform back from cₘₙ multi-spiral coefficients to cₖ polynomial coefficients using the matrix multiplication cₖ=\hat{Q}_{mn→k} [symbol] ₘₙ.

An awkwardness arises because normalization by S_{M} in Stage 1 is an aspect of the coefficient transformation: it is not an inherent part of the operations to be performed in Stage 3. Regardless of what operations are performed in Stage 3, exactly one factor of S_{M} should be present exiting Stage 3, in order for Stage 5 to produce the correct output polynomial.

For instance, if an ordinary polynomial multiplication is performed by standard means, P_{c}(t)=P_{A}(t)*P_{B}(t), and then P_{c}(t) is transformed into the unique-spiral representation, then the resulting coefficients cₘₚ will have multiplied into them one row normalization factor of S_{M} arising from the Stage 1 transformation [symbol] ₘₙ=\hat{Q}_{k→mn} [symbol] ₖ.

Whereas, if P_{A}(t) and P_{B}(t) are first transformed into the unique-spiral representation and then multiplied together, the result will have two factors of S_{M}, one from each of the aₘₚ and bₘₚ coefficients. Since this is not the correct result, one factor of S_{M} will need to be divided out of the product.

Similarly, unique-spiral representation division would cancel the factor of S_{M} out between the numerator and denominator, forcing a factor of S_{M} to be inserted in the output to be correct (i.e., consistent with the result of performing the division by traditional means and then transforming the result of the polynomial division into the unique-spiral representation). Similar problems would also arise with raising a polynomial to a power and other operations.

These problems may be avoided by delaying the Stage 1 normalization by S_{M}. Instead of row-normalizing with S_{M} once in Stage 1 and once in Stage 5, row normalization is not performed in Stage 1 and two factors of S_{M} are applied at Stage 5, producing the same final result. An analogy with scalar multiplication is that the product kabk can be converted into abk² without changing the final value.

This “delayed normalization” means that the S_{M} row normalization factor in Stage 3 does not have to be managed, because it is not present in Stage 3.

While it is obvious that the above scalar analogy of delayed normalization is correct (scalar multiplication is commutative), it is remarkable that in the spiral representation it is possible with matrix operations, as well as with the Stage 3 operations.

An apparent difficulty is that since S_{M} applies different row normalization factors depending on each row's m-value, it would initially seem that matrix multiplication and Stage 3 operations would spread the distinct m-value row normalization factors between the various cₘₙ and cₘₚ coefficients. Consequently, in Stage 5 it would be very difficult, and Stage 3 operation specific, to determine the row normalization that should be applied in order to produce the same result as if row normalization had been applied at Stage 1.

The reason that delayed normalization works for the spiral representation is that there is never any interaction anywhere in the system between coefficients with different m-values. Therefore, the row normalization factor may pass transparently through from Stage 1 to Stage 5. At Stage 5, the appropriate row normalization is fully determined by each row's m-value.

Delayed normalization is assumed in the description of the unique spiral operations described below. If row normalization is performed at Stage 1 then the unique spiral operations would need to be modified as described above in order to appropriately remove or insert factors of S_{M}. It will be understood by practitioners of ordinary skill in the art that while S_{M} was defined as a diagonal matrix, for purposes of the fast Q_{mn→k} algorithm it may be applied in 0(K) runtime as a scaling factor for each row of a column vector [symbol] ₘₙ.

The same considerations apply to Q_{mn→mp} and Q_{mp→mn} for which delayed normalization should also be applied. In the case of the slow matrix versions of the Q_{mp→mn} and Q_{mp→mn} this is a choice of applying no normalization on Q_{mn→mp} and applying it twice on Q_{mp→mn}. In the case of the fast versions of these transforms, since the design of Q_{mn→mp} starts with an unnormalized matrix, the fast algorithms inherently implement delayed normalization.

### Zero-Extension

Orthogonal projection of a polynomial into the multi-spiral representation requires that the polynomial have exactly a power-of-two number of coefficients. Further, if two or more polynomials are to be operated on jointly, for instance added together, the polynomials must have the same number of coefficients. Either of these requirements may force a polynomial to be augmented with additional high-term coefficients equal to zero, a process known as “zero extension”. Zero extension does not change the values that the polynomial computes (since the new high coefficients are all zero), it only makes the polynomial have the appropriate length.

Zero extension may also be necessary to support certain operations in the unique-spiral representation. Notably, it is known to the art that the multiplication of two polynomials by each other increases the number of terms of the resultant polynomial, as does raising a polynomial to some power.

The unique spiral operations assume that the length of the input polynomials had enough zero-value high-term coefficients to represent the result of the operations performed. For instance, if two polynomials with highest non-zero coefficient terms K-1 are to be multiplied together, then they should be represented by polynomials with 2K terms, the higher half of the coefficients of each being set to zero.

### Efficient Unique-Spiral Basic Operations

In the below operations, P_{A}(t) and P_{B}(t) are taken as input polynomials (operands), with output polynomial P_{c}(t) (resultant). The corresponding unique-spiral coefficients are aₘₚ, bₘₚ and cₘₚ respectively. The paired polynomial-based and unique-spiral-based operations provided below are equivalent in the sense that if the cₘₚ coefficients are transformed to polynomial coefficients, using methods described above, then the resulting polynomial will be identical to the P_{c}(t) polynomial calculated by traditional means.

The unique-spiral operations described here are divided into two types: those that act on spiral coefficients, and those that act on spiral exponents. Consider the terms cₘₚ Eₘₚ(t) for the possible values of m and p. The first type of operations takes the aₘₚ and bₘₚ coefficients as arguments and produces as output coefficients cₘₚ. The second type of operations takes the exponents of the Eₘₚ(t) as arguments, although the output only affects the coefficients cₘₚ.

An important distinction between these two types of operations is how the cₖ polynomial coefficients are represented. The exponent operators depend on the properties of the natural exponential, which is equivalent to a Taylor series. This means that for these operators, the coefficients must be Taylor coefficients. Conversely, for the coefficient operations, the coefficients cannot be represented as Taylor coefficients and must instead be standard algebraic polynomial coefficients. Consequently, for the unique-spiral exponent operations, the polynomial vector to be transformed into the multi-spiral representation should be in the form cₖ/k!, where the values of interest are cₖ. For the unique-spiral coefficient operations, the cₖ coefficients should be as is.

Because of this difference, the unique-spiral coefficient operations and the unique-spiral exponent operations may not be combined without switching the coefficient form between the two types of operations. There is not much need to combine the two types of operations in practice, but if it arises the coefficient form change may be produced by transforming from unique-spiral space to polynomial space, switching to or from Taylor coefficient form, and then transforming back to unique-spiral space. The exceptions to this rule are that addition and subtraction work equally well with either standard or Taylor polynomial coefficients.

The validity of the unique-spiral operations introduced below is backed by millions of numerical trials with randomly generated polynomials. Formal proof is also possible, but out-of-scope for current purposes as the focus is on practical applications.

Note that in all of the below operations the aₘₚ and bₘₚ coefficients are taken “as is”; no conjugates are used. All of the below operations select a matched pair (same m and p values) of each possible entry from [symbol] ₘₚ and [symbol] ₘₚ exactly once, corresponding to the K possible combined values of m and p. Therefore, the runtime of each of these operations is 0(K). No prior method known to the art supports both 0(K) addition and 0(K) multiplication on the same polynomials without requiring an intervening transformation.

### Unique-Spiral Coefficient Operations

$$Addition Law - {P}_{C} ( t ) = {P}_{A} ( t ) + {P}_{B} ( t ) \text{<=>} {c}_{mp} = {a}_{mp} + {b}_{mp} \qquad ( 59 )$$

$$Subtraction Law - {P}_{C} ( t ) = {P}_{A} ( t ) - {P}_{B} ( t ) \text{<=>} {c}_{mp} = {a}_{mp} - {b}_{mp} \qquad ( 60 )$$

$$Multiplication Law - {P}_{C} ( t ) = {P}_{A} ( t ) {P}_{B} ( t ) \text{<=>} {c}_{mp} = {a}_{mp} {b}_{mp} \qquad ( 61 )$$

$$Division Law - {P}_{C} ( t ) = {P}_{A} ( t ) / {P}_{B} ( t ) \text{<=>} {c}_{mp} = {a}_{mp} / {b}_{mp} \qquad ( 62 )$$

Even division, that is, when P_{B}(t) is a factor of P_{A}(t), results in a polynomial generated by cₘₚ that is identical to P_{c}(t). Non-even unique spiral division effectively creates more precision as needed by wrapping coefficients corresponding to negative powers of t around so that a polynomial coefficient that would ordinarily be interpreted as applying to a high power of t instead applies to a negative power of t. For the minor effort of tracking the change in term power values, the Division Law therefore provides a unified single output from a non-even divide, whereas traditional polynomial division, for instance using deconvolution, returns both a quotient and a remainder.

$$Power Law - {P}_{C} ( t ) = {{P}_{A} ( t )}^{R} \text{<=>} {c}_{mp} = {a}_{mp}^{R} \qquad ( 63 )$$

The Power Law follows directly from the Multiplication Law by multiplying a polynomial by itself R times. Performed directly, the unique-spiral power operation would require R-1 multiplications for each coefficient aₘₚ, and would therefore have runtime 0(R*K). However, it is known to the art that by grouping the expression a^{R} may be calculated with a logarithmic number of multiplications, so that the runtime of the unique-spiral power operation is 0 (log (R)*K). Assuming low R this is essentially 0(K).

It is known to the art that by first using an NTT, which allows for a linear-time multiplication, P_{A}(t)^{R} could be computed in runtime 0 (log (R)*K). However, while the runtime is the same, the unique-spiral operation retains the advantage that it does not require an intervening transformation to also perform linear-time addition or other operations, unlike the NTT.

### Unique-Spiral Exponent Operations

Integration and differentiation operations follow directly from the definition of

$${E}_{m p} = {e}^{{ti}^{( 2 p + 1 ) {2}^{2 - m}}} ,$$

by applying standard calculus rules for the natural exponential function:

$$Integration Law - {P}_{C} ( t ) = \int {P}_{A} ( t ) \text{<=>} {c}_{mp} = {a}_{mp} {i}^{- ( 2 p + 1 ) {2}^{2 - m}} \qquad ( 64 )$$

$$Differentiation Law - {P}_{C} ( t ) = \frac{d}{dt} {P}_{A} ( t ) \text{<=>} {c}_{mp} = {a}_{mp} {i}^{( 2 p + 1 ) {2}^{2 - m}} \qquad ( 65 )$$

Both unique-spiral integration and differentiation as provided above are 0(K), the same as the corresponding operations performed directly on polynomial coefficients by standard means. However, parameter shifting is more efficient in the unique-spiral representation than with standard polynomial representation.

For a known polynomial P_{A}(t) to find a polynomial P_{B}(s) for s=t+δt, the most direct way of solving this problem as known to the art would be to expand P_{A} (t+δt) as a series of weighted powers of t+δt; apply the binomial theorem for each; multiply the resulting powers St into their respective term coefficients; and then finally add terms with like powers of t across all terms generated. However, this procedure is not very efficient. The number of operations required for each binomial expansion is 0(K*log (K)); the log (K) because we are calculating powers (see above discussion of the unique-spiral power operation). There are K binomial expansions, so the overall order of the algorithm is 0 (K²*log (K)).

By contrast, the corresponding operation in the unique-spiral representation is 0(K). This is possible because of the well-known property of exponentials that e^{A+B}=e^{A}e^{B}. In this particular case

$${e}^{( t + δ t ) {i}^{( 2 p + 1 ) {2}^{2 - m}}} = {e}^{δ t * {i}^{( 2 p + 1 ) {2}^{2 - m}}} {e}^{t * {i}^{( 2 p + 1 ) {2}^{2 - m}}} ,$$

which allows the parameter shift to be separated out as a constant coefficient factor. This results in the Parameter Shift Law-

$${P}_{A} ( t ) \to {P}_{C} ( s ) for s = t + δ t \text{<=>} {c}_{mp} = {a}_{mp} {e}^{δ t * {i}^{( 2 p + 1 ) {2}^{2 - m}}} \qquad ( 66 )$$

### Further Applications

The cₘₚ basic operations provided above are directly useful in order to facilitate efficient computations for FHE, PQC, AI and other problem areas. Additionally, these operations also support important new methods as described below in exemplary applications. Other applications may also be derived from the unique-spiral representation as will be apparent to a practitioner of ordinary skill in the art.

### Individual Term Transformations and Orthogonality

As shown above, the matrix version of the Q_{k→mp} transformation may be formed by multiplying the Q_{k→mn} and Q_{k→mn} transformations. It was noted that the rows and columns of Q_{k→mp} are orthogonal. Normalization therefore produces a matrix \hat{Q}_{k→mp} whose columns form an orthonormal basis set.

$${\hat{Q}}_{k \to mp} = [ \begin{matrix}1 & 1 & 1 & 1 & 1 & 1 & 1 & 1 \\ 1 & - 1 & 1 & - 1 & 1 & - 1 & 1 & - 1 \\ 1 & - i & - 1 & i & 1 & - i & - 1 & 1 \\ 1 & i & - 1 & - i & 1 & i & - 1 & - 1 \\ 1 & {i}^{- \frac{1}{2}} & - i & {i}^{\frac{- 3}{2}} & - 1 & {i}^{\frac{3}{2}} & 1 & {i}^{\frac{1}{2}} \\ 1 & {i}^{\frac{- 3}{2}} & i & {i}^{- \frac{1}{2}} & - 1 & {i}^{\frac{1}{2}} & - 1 & {i}^{\frac{3}{2}} \\ 1 & {i}^{\frac{3}{2}} & - i & {i}^{\frac{1}{2}} & - 1 & {i}^{- \frac{1}{2}} & i & {i}^{\frac{- 3}{2}} \\ 1 & {i}^{\frac{1}{2}} & i & {i}^{\frac{3}{2}} & - 1 & {i}^{\frac{3}{2}} & - i & {i}^{- \frac{1}{2}}\end{matrix} ] diag ( [ \begin{matrix}1 / √ 8 \\ 1 / √ 8 \\ 1 / √ 8 \\ 1 / √ 8 \\ 1 / √ 8 \\ 1 / √ 8 \\ 1 / √ 8 \\ 1 / √ 8\end{matrix} ] ) \qquad ( 67 )$$

In the transformation cₘₚ=\hat{Q}_{k→mp}cₖ, each column of \hat{Q}_{k→mp} corresponds to the transformation of one polynomial coefficient cₖ. From left to right, c., the constant coefficient corresponds to the zeroth column of \hat{Q}_{k→mp}; and the seventh polynomial power coefficient c₇ corresponds to the seventh column of \hat{Q}_{k→mp}.

So, for instance, the cₘₚ coefficients corresponding to the fourth power of a polynomial will be

$$[ \begin{matrix}{c}_{0 , 0} \\ {c}_{1 , 0} \\ {c}_{2 , 0} \\ {c}_{2 , 1} \\ {c}_{3 , 0} \\ {c}_{3 , 1} \\ {c}_{3 , 2} \\ {c}_{3 , 3}\end{matrix} ] = {c}_{4} ( [ \begin{matrix}1 / √ 8 \\ 1 / √ 8 \\ 1 / √ 8 \\ 1 / √ 8 \\ 1 / √ 8 \\ 1 / √ 8 \\ 1 / √ 8 \\ 1 / √ 8\end{matrix} ] ) \qquad ( 68 )$$

One application of this formulation, due to the orthonormality of \hat{Q}_{k→mp}, is that for a particular set of coefficients cₘₚ, coefficient cₖ may be determined by calculating the dot product of cₘₚ coefficients with the corresponding column k of \hat{Q}_{k→mp}, which may be used to check whether a possible highest non-zero polynomial coefficient is in fact non-zero, without leaving the unique-spiral representation.

While sometimes useful for particular tests, performing the above operation on all columns of \hat{Q}_{k→mp} would amount to an 0(K²) transformation from cₘₚ to cₖ. This would not be a good choice on a serial computer as it was shown above that a faster 0(K*log (K)) algorithm exists for this purpose. However, on a parallel computer it may be possible in principle to calculate dot products with all columns in parallel, in which case the transformation runtime from cₘₚ to cₖ coefficients would drop to 0(K). Similar considerations apply to the reverse transformation \hat{Q}_{mp→k}, which may be used to express particular cₘₚ coefficients in terms of vectors of polynomial cₖ coefficients.

Another application of individual term projection is that it may be used to establish equations between polynomial terms that are expressed in the unique-spiral representation. A polynomial with a single unit-magnitude term, such as P_{A}(t)=1 or P_{A}(t)=t or P_{A}=t², may be transformed into the unique-spiral cₘₚ representation. One application of this is to solve for the inverse of a polynomial as described below.

### Polynomial Composition

The polynomial composition problem is to find a polynomial P_{c}(t) which is equivalent to a P_{A}(t) used as an argument to a P_{B}(t). That is,

$${P}_{C} ( t ) = {P}_{B} ( {P}_{A} ( t ) ) \qquad ( 69 )$$

If these polynomials are transformed into the unique-spiral representation as described above, coefficients aₘₚ and bₘₚ correspond to P_{A}(t) and P_{B}(t), respectively and the task is to find the coefficients cₘₚ corresponding to P_{c}(t).

The coefficients bₘₚ are the weights to the unique spirals Eₘₚ(t):

$${P}_{B} ( t ) = {\sum }_{m , p} {b}_{mp} {E}_{mp} ( t ) \qquad ( 70 )$$

P_{A}(t) may be inserted into the parameter t in P_{B}(t) to get

$${P}_{C} ( t ) = {P}_{B} ( {P}_{A} ( t ) ) = {\sum }_{m , p} {b}_{mp} {E}_{mp} ( {a}_{mp} {E}_{mp} ( t ) ) \qquad ( 71 )$$

An exponential function may be expanded as a power series to combine bₘₚ and aₘₚ coefficients in order to determine the cₘₚ coefficients. The expansion is:

$${\sum }_{m , p} {b}_{mp} {E}_{mp} ( {a}_{mp} {E}_{mp} ( t ) ) = {\sum }_{m , p} {b}_{mp} {\sum }_{m , p , k} {( {i}^{( 2 p + 1 ) {2}^{2 - m}} {a}_{mp} {E}_{mp} ( t ) )}^{k} \qquad ( 72 )$$

where k as usual is over all possible polynomial term powers.

In the above equation, the

$${i}^{( 2 p + 1 ) {2}^{2 - m}}$$

comes from the power expansion of the Eₘₚ associated with bₘₚ, and the remaining Eₘₚ is that associated with aₘₚ. The right side may be grouped as

$${\sum }_{m , p} {b}_{mp} {E}_{mp} ( {a}_{mp} {E}_{mp} ( t ) ) = {\sum }_{m , p} {b}_{mp} {\sum }_{m , p , k} {( {i}^{( 2 p + 1 ) {2}^{2 - m}} )}^{k} {( {a}_{mp} {E}_{mp} ( t ) )}^{k} \qquad ( 73 )$$

Using the power law, as defined previously, the above right factor may be written as:

$$( {( {a}_{mp} {E}_{mp} ( t ) )}^{k} = {a}_{mp}^{k} {E}_{mp} ( t ) \qquad ( 74 )$$

The powers of Eₘₚ(t) therefore drop out of the equation. Also, on the left side of the equation, the unique-spiral representation of P_{c}(t) may be substituted to yield

$${\sum }_{m , p} {c}_{mp} {E}_{mp} ( t ) = {\sum }_{m , p} {b}_{mp} {\sum }_{m , p , k} {( {i}^{( 2 p + 1 ) {2}^{2 - m}} )}^{k} {a}_{mp}^{k} {E}_{mp} ( t ) \qquad ( 75 )$$

At this point, coefficients cₘₚ (and therefore the composite polynomial) may be identified by expanding the summations on the right side, grouping by like m and p, and then matching the coefficients of Eₘₚ for the same values of m and p on the two sides of the equation, as will be apparent to practitioners of ordinary skill in the art.

### Polynomial Inversion and Related Problems

In the polynomial composition technique introduced above, in the equation

$${P}_{C} ( t ) = {P}_{B} ( {P}_{A} ( t ) ) \qquad ( 76 )$$

it was assumed that P_{A}(t) and P_{B}(t) were known and P_{c}(t) was to be determined. However, it is also possible that P_{A}(t) and P_{c}(t) are known and the task is to find P_{B}(t). The most notable instance of this problem is polynomial inversion, in which P_{c}(t)=t. That is:

$$t = {P}_{B} ( {P}_{A} ( t ) ) \qquad ( 77 )$$

For known P_{A}(t), a P_{B}(t) must be determined that will map P_{A}(t) back to t. P_{B}(t) is then the inverse of P_{A}(t).

As described above, polynomial term projection may be used to represent t as a unique-spiral vector [symbol] ₘₚ(k). Similar to polynomial composition, but with P_{B}(t) as the unknown, the equation may be written as

$${\sum }_{m , p} {t}_{mp} {E}_{mp} ( t ) = {\sum }_{m , p} {b}_{mp} {E}_{mp} ( {a}_{mp} {E}_{mp} ( t ) ) \qquad ( 78 )$$

which as before expands as

$${\sum }_{m , p} {t}_{mp} {E}_{mp} ( t ) = {\sum }_{m , p} {b}_{mp} {\sum }_{m , p , k} {( {i}^{( 2 p + 1 ) {2}^{2 - m}} )}^{k} {a}_{mp}^{k} {E}_{mp} ( t ) \qquad ( 79 )$$

The values bₘₚ can be found using linear algebra by means known to the art, involving matrix inversion or equivalent techniques, in order to determine the inversion of P_{A}(t) in cases where the inverse exists. In cases where the inversion does not exist the matrix to be inverted will be degenerate.

### Numeric Unique-Spiral Multiplication Example

This example gives the full computational details of a simple unique-spiral multiplication.

### Specify Polynomials

The below represents two polynomials as coefficient vectors with decreasing term powers, in order to be consistent with MATLAB convention. (This also implies a left-right flip of the Q_{k→mn} matrix transformation as compared to those provided above.) The length of each vector must be a power of two, with at least the highest-degree half of the coefficients equal to zero.

$${P}_{A} ( t ) = t + 1 = > {\vec{a}}_{k} = [ \begin{matrix}0 & 0 & 1 & 1\end{matrix} ] \qquad ( A \text{.1} )$$

$${P}_{B} ( t ) = 3 t + 2 = > {\vec{b}}_{k} = [ \begin{matrix}0 & 0 & 3 & 2\end{matrix} ] \qquad ( A \text{.2} )$$

The resulting product, calculated by standard means, is

$${P}_{C} ( t ) = 3 {t}^{2} + 5 t + 2 = > {\vec{c}}_{k} = [ \begin{matrix}0 & 3 & 5 & 2\end{matrix} ] \qquad ( A \text{.3} )$$

For a problem this simple, there is of course no reason to apply the unique-spiral multiplication law, except to display in simple form the operations that provide significant benefits at larger scale.

The coefficient transforms used here are for clarity the “slow” 0(K²) matrix multiplication versions, but could be replaced by the “fast” 0(K*log (K)) transforms as described previously.

Transform cₖ Polynomial to c_{Mn} Multi-Spiral Coefficients

The transformation from input polynomials to corresponding multi-spiral representations, consistent with the prior discussion of delayed normalization, employs a unnormalized transform matrix Q_{k→mn}

$${Q}_{k \to mn} = [ \begin{matrix}1 & 1 & 1 & 1 \\ - 1 & 1 & - 1 & 1 \\ 0 & - 1 & 0 & 1 \\ - 1 & 0 & 1 & 0\end{matrix} ] \qquad ( A \text{.4} )$$

The results of transforming the input polynomials to corresponding multi-spiral representations, Q_{k→mn} [symbol] ₖ′ and Q_{k→mn} [symbol] ₖ′, are:

$${\vec{a}}_{mn} = {[ \begin{matrix}2 & 0 & 1 & 1\end{matrix} ]}^{′} \qquad ( A \text{.5} )$$

$${\vec{b}}_{mn} = {[ \begin{matrix}5 & - 1 & 2 & 3\end{matrix} ]}^{′} \qquad ( A \text{.6} )$$

With the coefficients corresponding from the left to m=0, n=0; m=1, n=0; m=2,n=0; and m=2, n=1.

Transform cₘₙ Multi-Spiral to cₘₚ Unique-Spiral Coefficients

The transform from a multi-spiral representation Eₘₙ(t) to a corresponding unique spiral representation Eₘₚ(t) coefficients may be performed with the matrix

$${Q}_{mn \to mp} = [ \begin{matrix}1 & 0 & 0 & 0 \\ 0 & 1 & 0 & 0 \\ 0 & 0 & 1 & - i \\ 0 & 0 & 1 & i\end{matrix} ] \qquad ( A \text{.7} )$$

As with the previous Q_{k→mn} polynomial to corresponding multi-spiral representation transformation normalization may be delayed, so the rows do not have unit length. The results of Q_{mn→mp} [symbol] ₘₙ and Q_{mn→mp} [symbol] ₘₙ are:

$${\vec{a}}_{mp} = {[ \begin{matrix}2 & 0 & 1 - i & 1 + i\end{matrix} ]}^{′} \qquad ( A \text{.8} )$$

$${\vec{b}}_{mp} = {[ \begin{matrix}5 & - 1 & 2 - 3 i & 2 + 3 i\end{matrix} ]}^{′} \qquad ( A \text{.9} )$$

### Perform Mathematical Operation-Pairwise Multiply c_{Mp} Unique Spiral Coefficients

Linear pairwise multiplication of [symbol] ₘₚ and [symbol] ₘₚ gives the output unique-spiral coefficients of the product polynomial as:

$${\vec{c}}_{mp} = {[ \begin{matrix}10 & 0 & - 1 - 5 i & - 1 + 5 i\end{matrix} ]}^{′} \qquad ( A \text{.10} )$$

Note that this results from straight multiplication without conjugates.

Transform Output cₘₚ Unique-Spiral to cₘₙ Multi-Spiral Coefficients

The transformation from the output unique spiral representation with coefficients cₘₚ to the corresponding output multi-spiral representation with coefficients cₘₙ is the inverse of the map Q_{mn→mp} given above. The inverse of Q_{mn→mp} is its Hermetian with appropriate normalization. As per the discussion of delayed normalization, the square of the row normalizations of Q_{mn→mp}′ may be applied

$${Q}_{mn \to mp} = [ \begin{matrix}1 & 0 & 0 & 0 \\ 0 & 1 & 0 & 0 \\ 0 & 0 & 1 / √ 2 & 0 \\ 0 & 0 & 0 & 1 / √ 2\end{matrix} ] [ \begin{matrix}1 & 0 & 0 & 0 \\ 0 & 1 & 0 & 0 \\ 0 & 0 & 1 / √ 2 & 0 \\ 0 & 0 & 0 & 1 / √ 2\end{matrix} ] [ \begin{matrix}1 & 0 & 0 & 0 \\ 0 & 1 & 0 & 0 \\ 0 & 0 & 1 & 1 \\ 0 & 0 & i & - i\end{matrix} ] \qquad ( A \text{.11} )$$

resulting in

$${Q}_{mn \to mp} = [ \begin{matrix}1 & 0 & 0 & 0 \\ 0 & 1 & 0 & 0 \\ 0 & 0 & 0.5 & 0.5 \\ 0 & 0 & 0.5 i & - 0.5 i\end{matrix} ] \qquad ( A \text{.12} )$$

and multiplying [symbol] ₘₙ=Q_{mp→mn} [symbol] ₘₚ results in

$${\vec{c}}_{mn} = {[ \begin{matrix}10 & 0 & - 1 & 5\end{matrix} ]}^{′} \qquad ( A \text{.13} )$$

Transform cₘₙ Multi-Spiral Representation to Corresponding cₖ Polynomial Coefficients

The transformation from the output multi-spiral representation with coefficients cₘₙ to the corresponding output polynomial with coefficients cₖ is the inverse of the transform Q_{k→mn} given above. The inverse of Q_{k→mn} is its transpose with appropriate normalization. In the context of delayed normalization, as in the previous step, normalization is applied twice. The result is

$${Q}_{mn \to k} - [ \begin{matrix}0.25 & - 0.25 & 0 & - 0.5 \\ 0.25 & 0.25 & - 0.5 & 0 \\ 0.25 & - 0.25 & 0 & 0.5 \\ 0.25 & 0.25 & 0.5 & 0\end{matrix} ] \qquad ( A \text{.14} )$$

and multiplying [symbol] ₖ=(Q_{mn→k} [symbol] ₘₙ)′ results in

$${\vec{c}}_{k} = [ \begin{matrix}0 & 3 & 5 & 2\end{matrix} ] \qquad ( A \text{.15} )$$

which is consistent with direct multiplication of the specified polynomials by standard means.

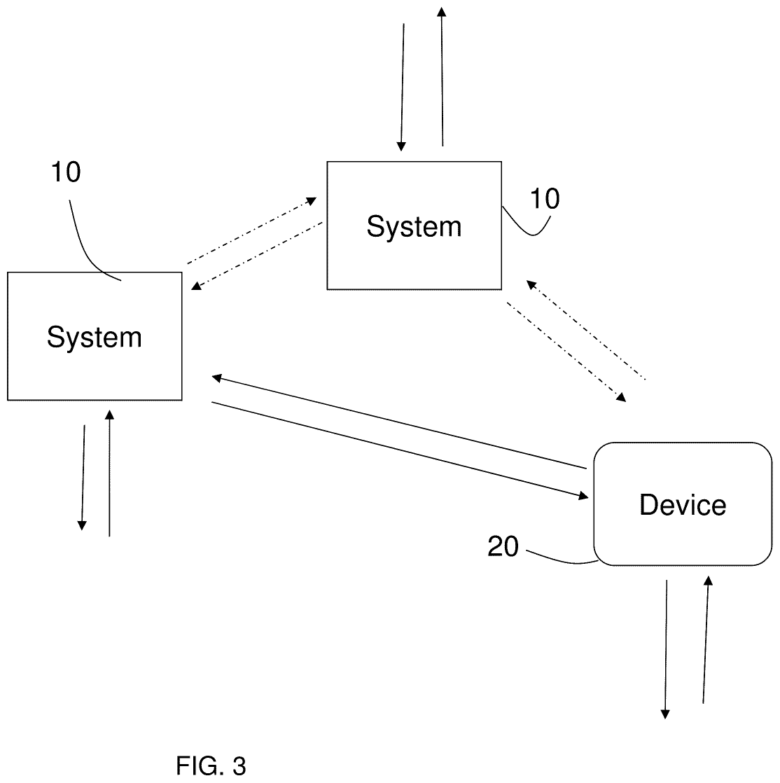

The present invention may be implemented in various systems 10 and/or devices 20 that may comprise a single processor at one location and/or one or more distributed systems 10 and/or devices 20, such as in exemplary FIG. 3, that may be remotely located in discrete location, in the cloud, or both in various combinations. The system 10 and devices 20 may communicate and/or interconnect via conventional wireline communication/transmission networks, terrestrial and/or satellite wireless communication/transmission networks, and combination thereof.

For example, health, financial, or other confidential information may be encrypted by an application or system and transformed into unique spiral representation, then transported to a system in the cloud or at one or more remote dedicated sites with instructions to perform various mathematical operations representing financial transactions, analyses, and other processing. The remote site returns the output from the operations to the application or system that sent the encrypted input and/or to a third-party system as may be identified in the process.

The capability of the present invention to perform operations on encrypted data enables third party intermediaries to provide confidential information computing services, remote or local, to entities without having to put the infrastructure and contracts in place to protect the information as the unencrypted data is never exposed to the third party.

The present invention may be employed as part of the PQC process, in which the transformations and mathematical operations are performed as part of the PQC process on input data. In this manner, the PQC process may effectively exploit the higher efficiency of the present invention for performing mathematical operations on polynomials at one or more stages of the process, thereby enabling broader application of PQC due to the reduced processing time involved.

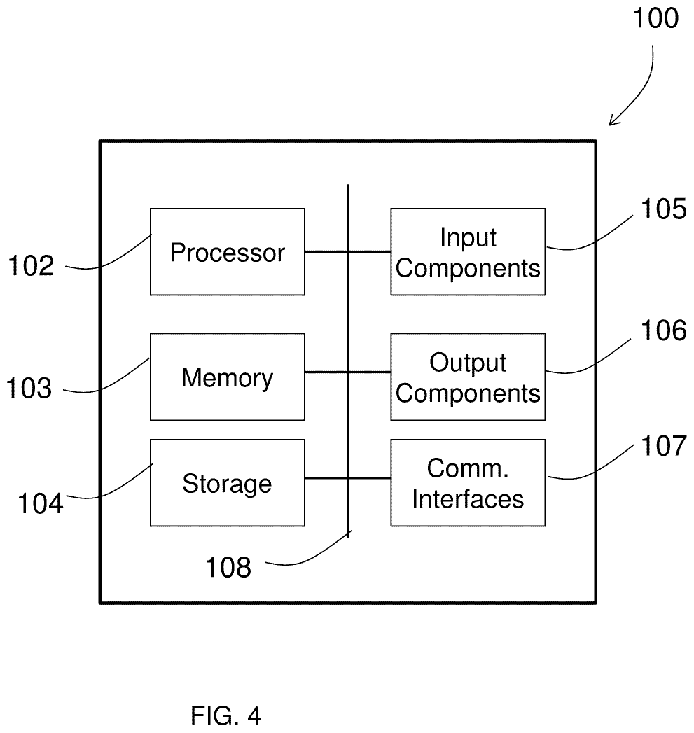

FIG. 4 illustrates exemplary component embodiments of various computing resources 100 that may be employed in the various systems 10 and devices 20, and methods of the invention in software and/or hardware. The computing resources 100 may each include one or more processors 102, memory 103, storage 104, input components 105, output components 106, communication interfaces 107, as well as other components that may be interconnected as desired by the skilled artisan via one or more buses 108. As previously described, the components of the various computing resources 100 may often be configured as a single device or multiple interdependent or stand-alone devices in close proximity and/or distributed throughout the system and/or devices.

Processor(s) 102 may include one or more general or Central Processing Units (“CPU”), Graphics Processing Units (“GPU”), Accelerated Processing Units (“APU”), microprocessors, and/or any processing components, such as a Field-Programmable Gate Arrays (“FPGA”), Application-Specific Integrated Circuits (“ASIC”), etc. that interpret and/or execute logical functions. The processors 102 may contain cache memory units for temporary local storage of instructions, data, or computer addresses and may be implemented as a single-chip, multiple chips and/or other electrical components including one or more integrated circuits and printed circuit boards that implements and executes logic in hardware, in addition to executing software.

Processor(s) 102 may connect to other computer systems and/or to telecommunications networks as part of performing one or more steps of one or more processes described or illustrated herein, according to particular needs. Moreover, one or more steps of one or more processes described or illustrated herein may execute solely at the processor 102. In addition, or as an alternative, one or more steps of one or more processes described or illustrated herein for execution in one processor may be executed at multiple CPUs that are local or remote from each other across one or more networks.

The computing resources 100 may implement processes employing hardware and/or software to provide functionality via hardwired logic or otherwise embodied in circuits, such as integrated circuits, which may operate in place of or together with software to execute one or more processes or one or more steps of one or more processes described or illustrated herein. Software implementing particular embodiments may be written in any suitable programming language (e.g., procedural, object oriented, etc.) or combination of programming languages, where appropriate.

The computing resources 100 may implement processes employing software to provide an embodiment of artificial intelligence, which may operate in place of or together with software to store experiential data from the Input Components 105, independently process the data in the processor 102, and use the results to improve performance against human provided criteria for performance. Improved performance may be conveyed though Output Components 106 and evident in embodiments.

Memory 103 may include Random Access Memory (“RAM”), Read Only Memory (“ROM”), and/or another type of dynamic or static storage device, such as flash, magnetic, and optical memory, etc. that stores information and/or instructions for use by processor 102. The memory 103 may include one or more memory cards that may be loaded on a temporary or permanent basis. Memory 103 and storage 104 may include a Subscriber Identification Module (“SIM”) card and reader.

Storage component(s)/device(s) 104 may store information, instructions, and/or software related to the operation of the system 10, device 20, and computing resources 100. Storage 104 may be used to store operating system, executables, data, applications, and the like, and may include fast access primary storage, as well as slower access secondary storage, which may be virtual or fixed.

Storage component(s)/device(s) 104 may include one or more transitory and/or non-transitory computer-readable media that store or otherwise embody software instructions, etc. implementing particular embodiments. The computer-readable medium may be any tangible medium capable of carrying, communicating, containing, holding, maintaining, propagating, retaining, storing, transmitting, transporting, or otherwise embodying software, where appropriate, including nano-scale medium. The computer-readable medium may be a biological, chemical, electronic, electromagnetic, infrared, magnetic, optical, quantum, or other suitable medium or a combination of two or more such media, where appropriate. Example computer-readable media include, but are not limited to fixed and removable drives, ASIC, Compact Disks (“CDs”), Digital Video Disks (“DVDs”, FPGAs, floppy disks, optical and magneto-optic disks, hard disks, holographic storage devices, magnetic tape, caches, Programmable Logic Devices (“PLDs”), RAM devices, ROM devices, semiconductor memory devices, solid state drives, cartridges, and other suitable computer-readable media.

Input components 105 and output components 106 may include various types of Input/Output (“I/O”) devices. The I/O devices often may include a Graphical User Interface (“GUI”) that provides an easy-to-use visual interface between the operator(s) and the system 10 and access to the operating system or application(s) running on the system 10 and/or control systems external to the system 10.

Input components 105 receive any type of input in various forms from users or other machines, such as touch screen and video displays, keyboards, keypads, mice, buttons, track balls, switches, joy sticks, directional pads, microphones, cameras, transducers, card readers, voice and handwriting inputs, and sensors for sensing information such as biometrics, temperature & other environmental conditions, location via Global Positioning System (“GPS”) or otherwise, accelerometer, gyroscope, compass, actuator data, which may be input via a user or received via one or more communication interfaces 107.

Output component 106 may include displays, speakers, lights, sensor information, mechanical, or other electromagnetic output. Similar to the input, the output may be provided via one or more ports and/or one or more communication interfaces 107.

Communication interface 107 may include one or more transceivers, receivers, transmitters, modulators, demodulators that enable communication, via wired and/or wireless connections onboard and remote from the system 10. Communication interfaces 107 may include Ethernet, optical, coaxial, Universal Serial Bus (“USB”), Infrared (“IR”), Radio Frequency (“RF”) including the various Wi-Fi, WiMax, cellular, and Bluetooth protocols, such as Bluetooth, Bluetooth Low Energy (BLE), Wi-Fi (IEEE 802.11), Wi-Fi Direct, SuperWiFi, 802.15.4, WiMax, LTE systems, LTE Direct, past, current, and future cellular standard protocols, e.g., 4-5G, Satellite or other wireless signal protocols or technologies as described herein and known in the art.

Bus(es) 108 may connect a wide variety of other subsystems, in addition to those depicted, and may include various other components that permit communication among the components in the computing resources 100. The bus(es) 108 may encompass one or more digital signal lines serving a common function, where appropriate, and various structures including memory, peripheral, or local buses using a variety of bus architectures. As an example and not by way of limitation, such architectures include an Industry Standard Architecture bus, an Enhanced Industry Standard Architecture (“EISA”) bus, a Micro Channel Architecture (“MCA”) bus, a Video Electronics Standards Association Local Bus (“VLB”), a Peripheral Component Interconnect (“PCI”) bus, a PCI-eXtended (“PCI-X”) bus, a Peripheral Component Interconnect Express (PCIe) bus, a Controller Area Network (“CAN”) bus, and an Accelerated Graphics Port (“AGP”) bus.

The computing resources 100 may provide functionality as a result of one or more processors 102 executing software embodied in one or more transitory or non-transitory computer-readable storage media residing in the memory 103 and/or storage 104 and logic implemented and executed in hardware. The results of executing the software and logic may be stored in the memory 103 and/or storage 104, provided to output components 106, and transmitted to other devices via communication interfaces 107, which includes cloud storage and cloud computing. In execution, the processor 102 may use various inputs received from the input components 105 and/or the communications interfaces 107. The input may be provided directly to the processor 102 via the bus 108 and/or stored before being provided to the processor 102. Executing software may involve carrying out processes or steps may include defining data structures stored in memory 103 and modifying the data structures as directed by the software.

Systems, devices, software, and methods of the present invention receive data, possibly as a bit sequence input, which may have been generated by user input, by extraction from data in an electronic memory record, by wired or wireless communication, or by using software and hardware analog and/or digital operations and is then encrypted. See the above Wikipedia citation for examples. The present invention is not limited to any specific encryption or data processing techniques, so long as those techniques may or do employ polynomial representations. Operations on this encrypted data may support a wide range of sensitive data applications, including but not limited to analysis and refinement of health data, financial data, technology data, etc. The results of these operations on encrypted data may only be decrypted by the owner of the data using a secret key not in general available to devices, persons and organizations performing allowed operations on the encrypted data.

Further, the polynomial operations disclosed here may also be used for unencrypted data, for instance to support efficient operations on AI or other polynomial data.

Aspects of the invention are disclosed in the specification and related drawings, which may be directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, a discussion of several terms used herein may be included.

The word “exemplary” is used herein to mean “serving as an example, instance, or illustration” and not as a limitation. Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein may be performed by specific circuits (e.g., application-specific integrated circuits (ASICs)), by field programmable gate arrays (FPGAs), by program instructions being executed by one or more processors, or by a combination thereof. Additionally, sequence(s) of actions described herein may be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments may be made by those skilled in the art without departing from the scope of the invention as defined by the following claims.

What is claimed is:

1. A method of fully homomorphically processing encrypted data represented by at least one input polynomial, comprising:
receiving, via at least one memory, encrypted data represented by at least one input polynomial having a degree K-1 and coefficients cₖ;
transforming, via at least one processor, the at least one input polynomial to provide corresponding multi-spiral representation of the at least one input polynomial having multi-spiral coefficients cₘₙ, where n is the integration number for a given m-level;
transforming, via the at least one processor, the multi-spiral representations of the at least one input polynomial to corresponding unique-spiral representations of the at least one input polynomial having unique-spiral coefficients cₘₚ, where p is the unique spiral specification for the given m-level;
performing, via the at least one processor, at least one mathematical operation on the corresponding unique-spiral representations to produce an output unique-spiral representation,
transforming, via the at least one processor, the output unique-spiral representation to an output multi-spiral representation; and
transforming, via the at least one processor, the output multi-spiral representation to an output polynomial having coefficients, where the output polynomial represents the result of performing the at least one mathematical operation on the encrypted data.

2. The method of claim 1, where the at least one mathematical operation includes at least multiplication and addition operations involving at least two input polynomials.

3. The method of claim 1, where the at least one mathematical operation includes at least one of multiplication, addition, subtraction, division, raising to a power, integration, differentiation, and parameter-shifting.

4. The method of claim 1, where transforming the input polynomial to the multi-spiral representation is performed by instantaneous spectral analysis.

5. The method of claim 1, where transforming the multi-spiral representation to the unique-spiral representation is performed using a transformation matrix A of the form
$$A ( n , p ) = {i}^{- n ( 2 p + 1 ) {2}^{2 - m}} .$$

6. The method of claim 1, where transforming the multi-spiral representation to the unique-spiral representation is performed with a runtime 0(K*log (K)).

7. The method of claim 1, further comprising:
encrypting unencrypted data to generate the input polynomial.

8. The method of claim 1, further comprising:
decrypting the output polynomial to generate output data.

9. The method of claim 1, where:
the data represents one of financial, personal, and security data.

10. The method of claim 1, where:
the data represents an account and the mathematical operations represents changes to be made to the account.

11. The method of claim 1, where:
performing the at least one mathematical operation is performed remotely from at least one of the transforming steps.

12. The method of claim 1, where:
the mathematical operations are performed to train a neural network.

13. The method of claim 1, further comprising
performing delayed normalization of the output multi-spiral representation.

14. The method of claim 1, where
the input polynomial is a Taylor series polynomial.

15. The method of claim 14, further comprising
converting the output polynomial to a non-Taylor series polynomial.

16. The method of claim 15, further comprising
performing the method of claim 1 using the output polynomial as the input polynomial.

17. A method of performing mathematical operations on data comprising:
receiving, via at least one memory, input data to be processed;
representing, via at least one processor, the input data represented by at least one input polynomial having a degree K-1 and coefficients cₖ;
transforming, via the at least one processor, the at least one input polynomial to provide corresponding multi-spiral representations of the input data having multi-spiral coefficients cₘₙ, where n is the integration number for a given m-level;
transforming, via the at least one processor, the corresponding multi-spiral representation to corresponding unique-spiral representations of the input data having unique-spiral coefficients cₘₚ, where p is the unique spiral specification for the given m-level;
performing, via the at least one processor, at least one mathematical operation on the unique-spiral representation of the input data to produce an output unique-spiral representation,
transforming, via the at least one processor, the output unique-spiral representation to an output multi-spiral representation;
transforming, via the at least one processor, the output multi-spiral representation to an output polynomial having coefficients, where the output polynomial represents the result of performing the at least one mathematical operation on the input data; and
converting, via the at least one processor, the output polynomial having coefficients, to output data.

18. The method of claim 17, where:
the input data is data to be encrypted; and
the at least one mathematical operation being performing is part of an encryption process.

19. The method of claim 17, where:
the input data is being encrypted using post quantum cryptography (PQC).

20. A method of processing data, comprising:
transforming, via at least one processor, at least one input polynomial representing data having a degree K-1 and coefficients cₖ to provide corresponding multi-spiral representations of the data having multi-spiral coefficients cₘₙ, where n is the integration number for a given m-level;
transforming, via the at least one processor, the corresponding multi-spiral representations of the data to corresponding unique-spiral representations of the data having unique-spiral coefficients cₘₚ, where p is the unique spiral specification for the given m-level;
performing, via the at least one processor, at least one mathematical operation on the corresponding unique-spiral representations of the data to produce an output unique-spiral representation,
transforming, via the at least one processor, the output unique-spiral representation to an output multi-spiral representation; and
transforming, via the at least one processor, the output multi-spiral representation to an output polynomial having coefficients, where the output polynomial represents the result of performing the at least one mathematical operation on the data.
